(19) United States
(12) Patent Application Publication
(10) Pub. No.: US 2020/0202663 A1
(43) Pub. Date: Jun. 25, 2020

(54) GAMING SYSTEM AND METHOD HAVING A PATH GAME FEATURE

(71) Applicant: ADP GAUSELMANN GMBH, Espelkamp (DE)

(72) Inventor: Michael Charles Halvorson, Las Vegas, NV (US)

(21) Appl. No.: 16/230,991

(22) Filed: Dec. 21, 2018

(51) Int. Cl. G07F 17/32

(52) U.S. Cl. CPC G07F 17/3213; G07F 17/3267; G07F 17/3272; G07F 17/3265

(57) ABSTRACT

A gaming system and method provides a path game feature by displaying a path and at least one graphical element (or avatar) associated with user. The path game feature may be triggered by the generation of one or more triggering symbols or triggering symbol combinations in a base game. The gaming system determines a movement rate of the avatar (e.g., based on the symbols combinations displayed in the base game and/or other factors). The gaming system displays the avatar as moving through sections of the path based on the movement rate and may evaluate an ending location of the avatar on the path for determining awards. The gaming system may further display and move other avatars, such as avatars associated with another player or the processor of the gaming system, and may determine awards based on the relative positioning and movement of the avatars.

### FIELD OF THE DISCLOSURE

The present disclosure relates to gaming devices.

### BACKGROUND

Gaming machines accept wagers from players in exchange for the opportunity to win awards or prizes. Current gaming machines use computing devices that control various technologies to provide specialized systems adapted to gain the attention of players and to keep them engaged with the gaming machines. To retain players' interest, gaming machines that offer new and unconventional functionality are needed.

### SUMMARY

Various implementations of a gaming system and method include a path game feature in which the gaming system displays a path and at least one graphical element (hereafter referred to as an “avatar”) associated with a player. The gaming system may position the avatar over or adjacent to one or more sections of the path. In some implementations, the path game may resemble a board game, and the gaming system may display the avatar as moving along or otherwise repositioned on the path to simulate the board game. For example, the game system may initially position the avatar at a starting section of the path and may subsequently move the avatar along the path and towards an ending section of the path. In alternative implementations, the path has no end section, creating a looping path.

In some implementations, the path may have a beginning section and an end section, and the gaming system may initially display the player's avatar at this beginning section. The gaming system may then move the player's avatar along the path toward the end section. In the path game feature, the gaming system may determine, for example, when the avatar has traveled past a certain section of the path (e.g., an end section associated with a finish line), after a given length of time, after certain actions by the player, after a randomly determined trigger, when a particular input is received from an administrator, etc. In some implementations, the gaming system may evaluate a location of the avatar (e.g., the section of the path where the avatar stopped) at the end of the play when determining an award. In some implementations, the path may have a rectangular or other closed loop shape, and the gaming system may display the avatar as traveling around the path multiple times.

In some implementations, the gaming system may display the avatar to be visually distinguishable from the path, such as displaying the avatar with a distinctive shape, image, and/or color. For example, the gaming system may display the avatar as having a rounded shape, such as an oval, and the sections of the path as having a substantially square or rectangular shape. As another example, the avatar can be displayed in the form of a vehicle. In some implementations, the gaming system may size the avatar to correspond to a size of one of the sections of the path. For example, the avatar may be sized to fit in one section of the path or to overlap two adjacent sections of the path. In some implementations, the avatar may resemble a board game piece, such as a vehicle, an animal, or some other suitable object. In some implementations, the gaming system may display the avatar with text, an image, or other visually distinctive feature identifying an associated player. In some implementations, the gaming system may vary the appearance of the avatar based on a received user input, such as to allow the user to select between different images, shapes, colors, text, etc. for the avatar. In some implementations, the gaming system may vary the appearance of the avatar based on occurrences within the path game feature, such as to vary an image, shape, color, text, etc. for the avatar when the avatar has moved a given distance along the path or is positioned at a section of the path associated with an award.

In some implementations, the gaming system may associate different sections of the path with different awards. The gaming system may display information identifying the respective awards associated with the sections of the path. In some implementations, the displayed awards associated with certain sections of the path may be modified based on the player's actions during a current or prior play of a game, an award from a prior play of a game, etc. For example, the gaming system may increase the awards in the path game feature based on an award from a base game, based on a wager by the player, etc. In some implementations, certain sections of the path modify a movement of the avatar, such as causing the avatar to move to a different section of the path (such as move forward given number of sections or to return to the start) or to change a movement rate of the avatar. Certain sections of the path may relate to special awards, such as an award that accumulates over multiple plays of a base game or the path game feature, or bonuses, such as a free play, providing the player within another avatar on the path, moving the avatar to a winning position on the path (e.g., go to the end). In some implementations, the gaming system may display payout amounts associated with at least some of the special awards in a central region of the path.

In some implementations, the gaming system may cause the player's avatar to have a movement rate, such as displaying the avatar as passing through a certain number of sections or along a given length on the path per unit of time, per user action, or per play. The gaming system may vary the movement rate of the player's avatar. For example, the movement rate may vary based on a quantity or frequency of plays, an action by the player in a base game or the path game feature, wagers by the player, etc. Additionally or alternatively, the movement rate may vary based on one or more sections of the path through which the avatar passes. In some implementations, the movement rate for an avatar may decrease to zero (e.g., stop) such that the avatar does not move during a time period or may become negative such that the avatar changes movement direction and returns to a previously passed section of the path. In some implementations, the path game feature may end when a movement rate of the player's avatar falls below a given level or stops.

In some implementations, the gaming system may display multiple avatars on the path and may move each of these avatars on the path. The gaming system may display the different avatars with different shapes, colors, images, and/or text. For example, each avatar may include text identifying an associated player. In some implementations, the gaming system may provide the path game as a racing game in which the avatars compete against each other, for example, to move to a particular end section of the path or to cover a particular distance along the path. The avatars may have different movement speeds, starting points, awards, etc. The movement rates of the avatars may vary based on, for example, a quantity or frequency of plays, an action by the player in a base game or the path game feature, wagers by the player, sections of the path contacted by the avatars, etc.

In some implementations, one or more of the avatars may be associated with a computerized non-playing character (e.g., a CPU avatar). The gaming system may automatically move the CPU avatar along the path, such as moving the CPU avatar through a given number of sections per turn or per unit of time. In some implementations, a movement and/or a position of a CPU avatar may affect a movement and/or position of a player's avatar. For example, the CPU avatar may function as an obstacle, and the gaming system may prevent the player's avatar from entering and/or passing a section of the path occupied by the CPU avatar. In another example, the gaming system may allow an avatar (e.g., the player's avatar) to enter a section of the path occupied by another avatar (e.g., the CPU avatar) and “bump” or displace that other avatar along the path, such as moving the other avatar to another section of the path (e.g., back to a starting section) or removing the bumped avatar from the path.

In some implementations, the gaming system may display two or more avatars associated with a player. For instance, the game system may display one or more additional avatars associated with a player as an award in the path game feature or a base game, when a player's avatar moves into a particular section of the path, an additional wager is received, etc. The player's avatars may move along the path, and the player may receive a sum of respective awards associated with the sections of the path corresponding to the stopping locations of the player's avatars. In another example, the path game feature may function as a race, and the player may receive an award associated with an ending location of the player's avatar that has moved furthest along the path. In yet another example, the player may select among the respective awards associated with the ending locations of the avatars on the path.

In some implementations, the gaming system may display avatars associated with two or more players. The gaming system may communicate with one or more other gaming systems to provide the path game feature over multiple gaming systems. For instance, the game systems may display avatars associated with different players in a tournament. Each of the avatars for the different players may move along the path during a play of the path game. In some implementations, the path game feature functions as a race. For example, the gaming system may end the path game feature, for example, after a certain time period, after one of the avatars reaches a particular section of the path (e.g., an end section), after one of the avatars travels a particular distance on the path, a stop instruction is received from an administrator, or other triggering event. The gaming system may evaluate respective stopping locations of one or more of the avatars to determine a payout amount associated with the stopping location of the avatars. In another example, the gaming systems may determine one or more of the players to be winners based on the respective movements of the respective avatar, such as providing an award to the player associated with a first avatar to complete the path.

In some implementations, the game system may provide the path game as a bonus feature (also referred to as a bonus game, a feature game, or a special game). For example, the game system may display the path and the one or more avatars in a different portion of screen or in a different screen from a base game. The path game feature may be triggered based on a player's actions in the base game or as award in a base game. For example, game system may provide the path game feature when the player places a wager in the base game. In another example, game system may provide the path game feature as a prize for the base game, based on certain occurrence in the base game, or based on certain actions by the player in the base game, such as the player making a certain quantity of plays or wagers in the base game. In some implementations, the gaming system determines whether a bonus controller outputs a bonus game triggering signal to trigger the path game. Furthermore, the movement of a player's avatar along the path may be determined based on the player's actions in the base game and/or based on one or more awards earned by the player in the base game.

In some implementations, the game system may provide a base game that includes symbol display areas associated with video-based slot machine reels (also herein referred to as “reels”). For example, the game system may provide a base game that includes five reels that are each associated with three symbol display areas. The base game may further include symbol sets that provides symbols associated with the reels. In some implementations, each reel is associated with a different symbol set. Furthermore, the base game may include pay lines corresponding to various combinations of symbol display areas. A player may selectively activate one or more of the pay lines by placing wagers on such pay lines. For example, selecting a minimum wager amount may activate only one pay line, selecting additional wager amounts may activate additional pay lines, and selecting a maximum wager amount may activate all pay lines. In some implementations, the movement of a player's avatar along the path may be determined based on the wager amount, the number of pay lines activated, etc.

In some implementations, the gaming system may evaluate the displayed symbols in the base game to identify winning symbol combinations and determine a payout amount based on the winning symbol combinations along wagered pay lines. In some implementations, the gaming system may evaluate the displayed symbols in the base game to identify triggering symbol combinations and determine whether to trigger the path game feature based on the triggering symbol combinations along wagered pay lines. For example, the gaming system may evaluate the displayed symbols of the base game for the presence of one or more symbols or symbol combinations that trigger the path game.

In some implementations, the movement of a player's avatar along the path may be determined based on one or more of the symbols displayed in the symbol display areas associated with video-based slot machine reels. For example, the gaming system may evaluate the displayed symbols to identify symbols or combinations of symbols causing an avatar to move along the path and then determine, as described above, a payout amount based on the movement and/or location of the avatar along the path.

In some implementations, at least one symbol from the symbol sets may be designated as a triggering symbol. When the gaming system determines that at least a predetermined quantity of triggering symbols are displayed (e.g., one or more triggering symbols), the gaming system may determine that the path game feature is triggered. Upon determining that the bonus game is triggered, the gaming system may display the path and one or more avatars, execute the path game (e.g., to move an avatar on a path), evaluate the path game (e.g., determine an award associated with an ending position of the avatar on the path), and issue the player any award determined for the path game feature, as described below. In some implementations, the gaming system will execute the path game as a bonus game while the player continues to play one or more plays of the base game.

In some implementations, the path game may resemble a static wheel of awards placed in various sections of the static wheel, and the gaming system may display an award indicator as moving along or otherwise being randomly repositioned on sections of the static wheel to indicate which of the awards the player wins when the award indicator is stopped along the static wheel.

As described above and set forth in greater detail below, gaming systems in accordance with aspects of the present disclosure provide a specialized computing device including non-conventional hardware and software that improve upon the existing technology of human-computer interfaces by providing functionality of generating display outputs that enable players to enjoy different paths games and generate new awards. Doing so improves the operation of the gaming systems for their specialized purpose by reducing player disappointment with game outcomes and enhancing player excitement for plays of a game.

### BRIEF DESCRIPTION OF THE DRAWINGS

FIG. 1 shows a perspective view illustrating an example gaming system in accordance with aspects of the present disclosure.

FIG. 2 shows a functional block diagram illustrating a gaming system in accordance with aspects of the present disclosure.

FIG. 3A-3C show process flow diagrams illustrating an example method of operating the gaming system that provides a path game feature in accordance with aspects of the present disclosure.

FIGS. 4A and 4B show pictures of gaming system display illustrating an example of a base game in accordance with aspects of the present disclosure.

FIGS. 5A-5F show pictures of a gaming system display illustrating examples of a path game feature in accordance with certain aspects of the present disclosure.

FIGS. 6A-6G show pictures of a gaming system display illustrating examples of a path game feature in accordance with other aspects of the present disclosure.

FIG. 7 shows a picture of a gaming system display illustrating an example of a path game feature in accordance with an aspect of the present disclosure.

### DETAILED DESCRIPTION

Various implementations of gaming systems and methods consistent with the present disclosure include providing a path game feature by displaying a path and at least one graphical element (or avatar) associated with user. In some implementations, the path game feature may be triggered by a based game, such as a gaming system generating and displaying a predetermined triggering symbol or symbol combination. The gaming system may determine a movement rate of the avatar. The movement rate may be predetermined, randomly determined, based on the generated and displayed symbol combinations and/or other factors. The gaming system may display the avatar as moving through sections of the path based on the movement rate and may evaluate an ending location of the avatar on the path for determining one or more awards. The gaming system may further display and move other avatars, such as avatars associated with another player or an avatar associated with the gaming system computer, and may determine awards based on the relative positioning and movement of the avatars.

In some implementations, a gaming system includes a cabinet, a processor, a display device supported by the cabinet, an input device supported by the cabinet, a value acceptor supported by the cabinet, a value dispenser supported by the cabinet, and a memory device that stores program instructions. The program instructions, when executed by the processor, control the gaming device to perform operations including establishing a credit balance based at least in part on a monetary value received by the value acceptor. The operations can also include placing a wager following receipt of a wager input via the input device, the credit balance being decreased by the wager. The operations can also include providing a path game feature that includes displaying, on a display device, a path and an avatar associated with a player, and moving the avatar along the path. The operations can also include randomly generating symbols from symbol sets and displaying, on the display device, the generated symbols in a number of symbol display areas, whereby the symbol display areas may be arranged in columns of symbol display areas. The operations can include evaluating the displayed symbols for winning symbol combinations or for symbol combinations that trigger a movement of the avatar in the path game feature. In another example the operations can also include evaluating the displayed symbols for symbol combinations that initially trigger the path game feature. The operations can also include evaluating an ending position of the avatar for winning locations along the path. The operations can further include displaying, on the display device, an award based on any winning symbol combinations or the winning locations on the path, the credit balance being increased by the award, and issuing value from a value dispenser based on the credit balance upon receipt of a cash out request or signal via an input device.

### Gaming Device Platform

The features and advantages of the gaming system and method described herein may be provided to a player via a gaming device platform that includes various structures and components for allowing player interaction with the gaming device. While only one gaming device platform will be described in detail herein, it is understood that the features, objects, and advantages of the gaming system described herein may be implemented in one or more alternative gaming device platforms.

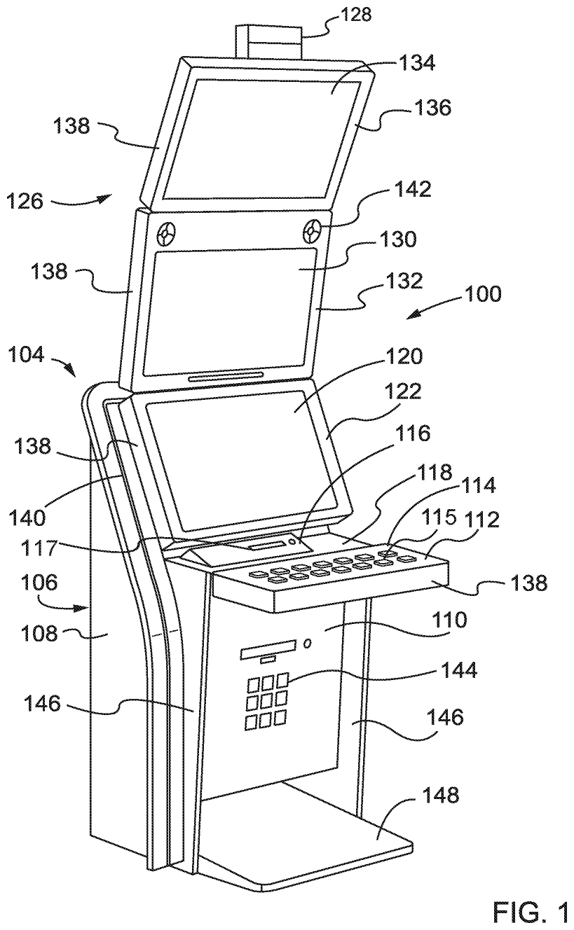

FIG. 1 shows a perspective view illustrating an example of gaming system 100 in accordance with aspects of the present disclosure. Such gaming system 100 may be referred to as a slot machine and, as illustrated, is housed in a cabinet 104 (e.g., a housing) constructed so that a player can operate and play the gaming system 100 while standing or sitting. The cabinet 104 can include a lower cabinet body portion 106, which includes a pair of cabinet side panels 108 (only one of which is viewable in the perspective view of FIG. 1), a front panel 110, and a rear panel (not shown). Additionally, a base panel (not shown) and a top panel surface (not shown) may support a first game display device 120 and the player interaction area 112. The cabinet panels 104, 106, 108, 110 (as well as the base panel and the top panel surface) may be interconnected along their edges and cooperate to form the cabinet 104, which encloses and houses components of the gaming system 100, as can be seen in FIG. 1. The cabinet 104 may function to securely protect local control system, technology components, and provide support for game display(s) and player input and output interactions with the gaming system 100, such as describe herein below.

While the example cabinet 104 is depicted as having a particular shape, structure, and organization, it should be appreciated that a wide variety of cabinet enclosure sizes, shapes, and designs are possible for the gaming system 100. For example, the cabinet panels 104, 106, 108, 110 (as well as the base panel and the top panel surface) may be combined into fewer elements or divided into additional elements. Additionally, the positions of the displays (e.g., first display device 120) and input/output devices can be reorganized and/or relocated with respect to one another.

In accordance with aspects of the present disclosure, a player can interact with the gaming system 100 in various ways to direct the wagering and game play activities and preferences. More specifically, the cabinet 104 includes input and output areas generally designated as the player interaction area 112. The player interaction area 112 may be located on the front top side of cabinet 104 and, as shown, on a panel structure that extends outwardly from the gaming system 100 in a player's direction. The player interaction area 112 may contain player input and output structures, including a player control area 114, a player value acceptor and dispenser area 116, and player convenience input area 118.

The player control area 114 includes one or more input devices 115, such as buttons or touch sensitive areas, through with which players may interact with the gaming system 100 so as to direct game play. It is expected that the cabinet 104 provides an easily accessible location and support for player input/output (I/O) interactions with the gaming system 100, including gaming control interactions and value wagering interactions. Although the gaming system 100 illustrated in FIG. 1 shows the input devices 115 of the player control area 114 as physical controls (e.g., buttons), it is understood that in some implementations, a player's gaming control interactions could be made by either the physical controls or functionally equivalent “soft” controls (e.g., soft buttons) located on the gaming display and activated by player touch (e.g., touch screen interfaces), or a combination of both arrangements.

The input devices 115 may include the following: game selection button(s) in any implementation where more than one game is provided in a single gaming system 100; gaming denomination value selection button(s) in any implementations where one or more wagering denomination value is accommodated; wager selection button(s) for the player to indicate or select the desired wager value for a game in any implementations where a selection of wager values are offered; pay line selection button(s) for selecting the number of active pay lines in game implementations that provide multiple pay line wagering; a reel spin button for players to initiate one or more reels to spin in a game; a repeat last bet button for players to conveniently repeat the last game's preference and wager selections in a new game; a cash-out button for player extraction of gaming device credits; an attendant call button; and gaming device information buttons such as show pay tables, show game rules, or show other game-related information.

The player value acceptor and dispenser area 116 may include one or more value acceptance and value distribution devices 117 that allow the player to interact with the gaming system 100 and to risk or otherwise place a wager (a monetary value) on one or more outcomes of a game. The value acceptance and value distribution devices 117 may return winnings to the player via some form of value distribution. In the player value acceptor and dispenser area 116, a player can supply monetary value to the gaming system 100 via the value acceptance and value distribution devices 117. In some implementations, the value acceptance and value distribution devices 117 may accept any one or more of the following from a player to establish a gaming credit balance: coins, bills, tokens, tickets/vouchers, player ID cards, credit cards, or other suitable forms of value. Thus, if the gaming system 100 accepts coins and bill, the value acceptance and value distribution devices 117 may comprise a currency bill validator and a coin validator. Likewise, if the gaming system 100 accepts tickets, the value acceptance and value distribution devices 117 may comprise a ticket acceptor that receives tickets or vouchers representing some monetary value. The ticket acceptor may include a bar code reader, or other appropriate code reader, for reading the encoded value contained by the player's ticket or voucher. In some implementations, value acceptance and value distribution devices 117 can accept more than one type of value. In some implementations, the player value acceptor and dispenser area 116 may include multiple different value acceptance and value distribution devices 117 that accept different types of value from players.

Upon receipt of some type of value from the player, the value acceptance and value distribution devices 117 of the player value acceptor and dispenser area 116 can perform validation on the player supplied value using appropriate hardware readers (e.g., determining that the currency bills/coins/tokens are genuine or the ticket/voucher is genuine). If the validation result is positive on player supplied value, the value acceptance and value distribution devices 117 can generate a signal to a processor of the gaming system 100 that establishes a gaming credit balance for playing one or more games on gaming system 100.

In some implementations, the value acceptance and value distribution devices 117 dispenses a monetary value, or a representation thereof, from the gaming system 100 when a player chooses to “cash out” the gaming credit balance (e.g., remove value from the gaming system 100). The player can cash out at any suitable time. When a player cashes out the value contained on a credit meter (not shown) of gaming system 100, a processor of gaming system 100 may cause a printer included in the value acceptance and value distribution devices 117 to print and dispense a coded ticket or voucher through a dispensing slot to the player. The coded ticket or voucher may be a bar-coded ticket or any other suitable code (PDF417 coding or quick response (QR) coding). This ticket can then be used as value input at another gaming device or converted to currency at a conveniently located kiosk or cashier counter located near the gaming device. Alternatively, the processor of gaming system 100 may cause a currency bill dispenser or a coin dispenser included in the value acceptance and value distribution devices 117 to dispense the value contained on the credit meter of gaming system 100.

Various combinations of the above value acceptance and value distribution arrangements are possible. The gaming system 100 may include other value acceptance and value distribution mechanisms in the player value acceptor and dispenser area 116. For example, the value acceptance and value distribution devices 117 may include a magnetic strip or chip card reader/writer in order to accept value from and transfer value to a magnetic strip or an embedded chip card. In other implementations, the value acceptance and value distribution devices 117 may include hardware for transferring (and receiving) non-traditional currencies to players such as digital currencies (e.g., bitcoin).

In some implementations, the value acceptance and value distribution devices 117 may include a card reader that accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming system 100 may be associated with the player account. Additionally, a numeric or alphanumeric keypad (not shown) may be provided adjacent to the card reader slot that enables player entry of a personal identification number or the like for secure access to card information.

In some implementations, a player convenience input area 118 may be included in the gaming system 100, as is shown in FIG. 1. In various implementations, player convenience input area 118 may have a variety of features and functions depending on the jurisdictional deployment of the gaming system 100. In some implementations, the player convenience input area 118 may house a magnetic strip card reader (not illustrated), integrated circuit chip card reader (not illustrated), or both, for reading cards associated with a player loyalty program. Player loyalty programs, also referred to as player tracking systems, provide magnetic strip or chip cards to players for insertion into the gaming system 100 during play. These player loyalty/player tracking cards may be associated with a player account and are utilized by the card-issuing entity to monitor or track a player's gaming activity and build loyalty through player rewards of a variety of types. The player convenience input area 118 may include an input mechanism such as input buttons so that a player may input a personal identification number or other require player information associated with the player tracking card. Further, the input mechanism may also include a small display utilized to communicate player information to the player such as the player's current loyalty rewards.

In certain implementations, the player convenience input area 118 may include player convenience features such as a pocket for storage that allows players to store their personal items such as a mobile phone. The gaming system 100 may include one or more universal serial bus (USB) ports that enables a player to charge their electronics or connect to services such as the Internet or food service. Further, player convenience input area 118 of the gaming system 100 may include buttons to request food or drink service if the gaming device is located in an establishment that has food and drink service. The gaming system 100 may be connected to a local or wide area network such that selection of the requested food or drink service may alert the establishment's hospitality staff to deliver the requested service directly to the gaming system 100.

The layout of the player control area 114, player value acceptor and dispenser area 116, and the player convenience input area 118 in gaming system 100 may be arranged differently than those disclosed and illustrated herein. The selections and arrangement of input locations on the cabinet 104 may be dependent upon the game buttons, the type of value wagered, and the player conveniences utilized in the deployment configuration of gaming system 100.

With continuing reference to FIG. 1, in some implementations, the lower cabinet body portion 106 includes the first game display device 120, which can be mounted atop or flush with a top panel surface of the lower cabinet body portion 106. The first game display device 120 can be, for example, a 27-inch liquid crystal display (LCD) display mounted in a widescreen orientation. However, any suitable display may be used in any suitable orientation. In the illustrated implementation, the first game display device 120 can mounted within and framed by first display frame 122 which is, in turn, mounted upon lower cabinet body portion's top panel surface. In this manner, the first game display device 120 is both surrounded and secured within the first display frame 122 and raised above the cabinet's top panel surface. Additional features of the first display frame 122 are described below. In some implementations, the gaming system 100 may use a single first game display device 120 and not include additional game displays (not illustrated). For example, a single first game display 120 may span the one or more portions of the cabinet 104 (e.g., lower body cabinet portion 106 and upper body cabinet body portion 126, described below) in place of other display devices (e.g., display devices 130 and 134, described below).

The lower cabinet body portion 106 can be further constructed to support an upper cabinet portion 126. The upper cabinet portion 126 may be comprised of an upwardly extending support structure (not illustrated) that extends upwardly from the rear side of lower cabinet body portion 106 configured to mechanically support one or more additional game displays.

At the topmost end of the support structure, a cabinet top light 128 may be provided. The cabinet top light 128 is capable of illumination in a variety of colors and is utilized to indicate and communicate conditions of the gaming system 100 to gaming players and service personnel.

Further, the upper cabinet portion support structure may conceal power and communication lines between (1) the control systems and components located within the lower cabinet body portion 106 and (2) the displays mounted on the upper cabinet portion 126 support structure.

In some implementations, as illustrated in FIG. 1, gaming system 100 includes additional displays, including a second game display device 130 and a third game display device 134. The second game display device 130 and the third game display device 134 can be disposed generally in a vertical relationship and generally in alignment with the first game display device 120. Like the first game display device 120, the second game display device 130 and the third game display device 134 can be 27-inch LCD displays and can be mounted in a widescreen orientation in some implementations. However, any suitable display in any suitable orientation may be used for the second game display device 130 and the third game display device 134. Further, like the first game display device 120, the second game display device 130 and the third game display device 134 can be mounted within and framed by second display frame 132 and third display frame 136, respectively. The second display frame 132 and the third display frame 136 can be attached to the upper cabinet support structure and can protect the second game display device 130 and the third game display device 134.

The first game display device 120, the second game display device 130, and the third game display device 134 can be disposed at an angle from each other to form a player-facing concave arc. However, in some implementations, the angles between the displays 120, 130, and 134 may be adjustable and may be smaller or greater than the angles illustrated in FIG. 1. Further, it is understood that in some implementations the displays may be disposed in a common plane relative to each other.

It also should be appreciated that in various implementations a variety of display technologies may be utilized equivalently and interchangeably with a variety of implementations of the gaming device. Equivalent display devices include all variations of liquid crystal displays, light emitting diode displays, and plasma displays.

In some implementations, different sized displays may be combined to display gaming data on gaming system 100. As a non-limiting example, a 27-inch widescreen LCD display may be combined with a 20-inch portrait-oriented LCD or a light emitting diode (LED) display. This combination may be used, for example, with a third scrolling banner LED display. In alternative implementations, one, two, three, or more displays could be used in a variety of positions and orientations. Any suitable combination may be used. It should also be appreciated that a processor of gaming system 100 may communicate with the disclosed first game display device 120, second game display device 130, and third game display device 134 through a video card of gaming system 100 to produce the visible aspects of a game.

In some implementations, one or more of the first game display device 120, the second game display device 130, and the third game display device 134 may be fitted with a transparent touch sensitive overlay for sensing player touch inputs into the gaming system 100. The touch sensitive overlays can communicate with a processor of gaming system 100 to enable the player to interact with the game.

In some implementations, the curved displays may be used for any or all of the first game display device 120, the second game display device 130, or the third game display device 134. Similarly, any of the displays used for gaming system 100 can be based on flexible display technologies. For example, it is possible to utilize flexible display technologies to create uniquely shaped curving, wavy, or tubular display structures to provide one or more of the first game display device 120, the second game display device 130, and the third game display device 134. Additionally, in some implementations flexible display technologies can be used in combination with fixed flat screen technologies.

While the gaming system 100 has been described as implemented with video technologies, in some implementations, mechanical reels with reel strips containing game indicia and step motor controllers may be employed to provide game information to a player. In some implementations, the reel strips may include printed symbols. In another implementation, the mechanical reels may include flexible video display technology as the reel strips on mechanical reels. Thus, games implemented in video form can readily be implemented with mechanical reels utilizing such display technology. Alternatively, in other implementations mechanical reels with reels strips having fixed symbols displayed along the reel strip could be used to implement the game.

Dependent upon the particular gaming device housing style, a variety of other display technologies may be utilized in combination with the gaming device disclosed herein. For example, the gaming system 100 may have one or more display devices in addition to the base game display(s) in some implementations. For example, the gaming system 100 may include a player tracking device having a player tracking display which displays various information to the player regarding the player's status. The gaming system 100 may also include other game-related displays such as the wager display and the gaming credit balance display. These additional game-related displays may be separate display devices or may be displayed on any one or more of the first game display device 120, the second game display device 130, or the third game display device 134.

The gaming system 100 may also include cabinet lighting design functions to attract players. In the example gaming system 100 illustrated in FIG. 1, attractive cabinet lighting is provided by frame accent lighting 138. It is noted that frame accent lighting 138 is a common structure found on the first display frame 122, the second display frame 132, and the third display frame 136 and player interaction area 112. Example areas where frame accent lighting is applied to the gaming system 100 are commonly designated as frame accent lighting 138.

Frame accent lighting 138 may have multiple components. The side edge pieces of first display frame 122, second display frame 132, third display frame 136, and the edge structure of player interaction area 112 can be made of a translucent or transparent plastic or other suitable materials. Linear arrays, or strips, of light emitting diodes (LEDs) (not shown) on circuit boards may be mounted below the translucent or transparent plastic side edge pieces 138. In some implementations, the circuit boards are flexible circuit boards. These LED strips and transparent or translucent coverings may surround one or more gaming device displays frames, as well as the player interaction area, to highlight these areas.

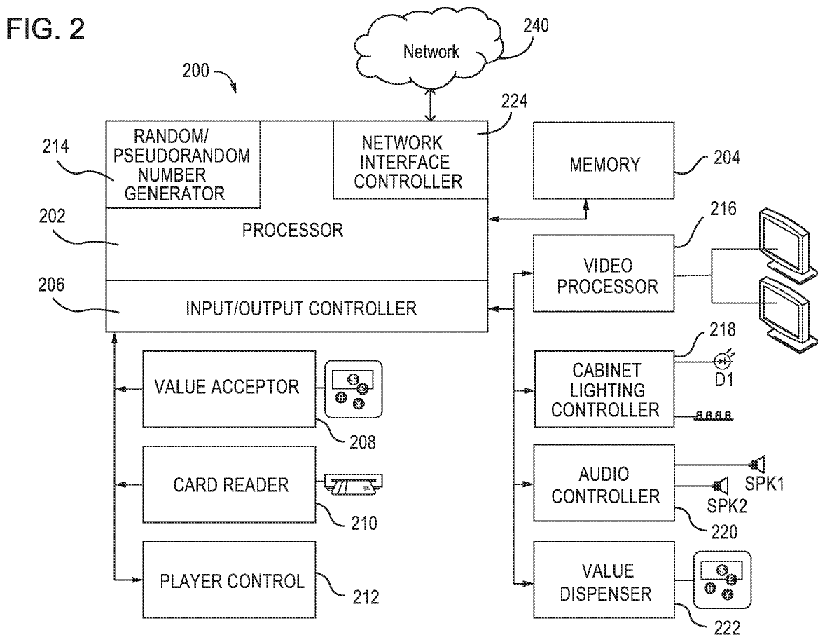

In some implementations, the individual LEDs mounted on the LED strips are of a type that can emit red, green, and blue light. In an alternative implementation, separate LEDs are used for the light colors. All LED strips can be electrically connected and can be controlled by a cabinet lighting controller (e.g., cabinet lighting controller 218 in FIG. 2) in conjunction with a processor of the gaming system 100 to selectively mix the emitted light colors in a manner to create any color. The cabinet lighting controller can flash and vary lighting as desired. For example, cabinet edge lighting can change and flash in combination with music rhythms or in combination with game events. Other variations are possible.

In some implementations, cabinet 104 may include LED strip lighting or LED rope lighting to accentuate the cabinet and enhance the attractiveness of the gaming system 100 to players. LED rope lighting is a number of small light-emitting diode bulbs linked together and encased in a plastic, polyvinylchloride, or other suitable material to create a string of lights. For example, in one implementation illustrated in FIG. 1, cabinet 104 includes cabinet accent lighting 140. In some implementations, cabinet accent lighting 140 is LED rope lighting mounted flush with the front side edge of the cabinet side panels 108. The LED rope lighting can generate any of suitable colors and are controlled by cabinet lighting controller and a processor of gaming system 100 to selectively mix the emitted light colors in a manner to create any color in the same manner as the frame edge lighting.

In various implementations, gaming system 100 includes one or more audio speakers 142 and appropriate driving electronics and sound cards so that game players may experience pleasing audio aspects of the gaming system 100. Audio is desirable to attract and maintain player interest in gaming system 100. The gaming system 100 may also emit attraction sounds during any idle period of gaming system 100. Game audio may add to the player's enjoyment of gaming system 100 by providing music and sound effects designed to enhance and compliment the gaming experience. In FIG. 1, the audio speakers 142 are shown mounted on the upper corners of second display frame 132. Any suitable number of additional speakers 142 may be provided on additional display frames or on the lower cabinet body portion 106 as desired.

The speakers 142 designed for emitting bass vibrations may be included in some implementations. Placement of the speakers 142 may be selected to enhance the sound emitting characteristics of the gaming system 100. For example, bass speakers or additional speakers 144 may be mounted inside lower cabinet body portion 106. Further, it is envisioned that in some implementations sound processing such as multichannel processing and surround sound processing are included in gaming system 100. Audio jacks for attachment of player headphones may also be provided in some implementations of gaming system 100 for the player to further enhance the audio experience of the game and also to block out noise from other gaming devices.

In some implementations, the front panel 110 of lower cabinet body portion 106 includes a locked removable panel or locked door (not shown), which can be opened for access to internal control system and technology components that are housed within lower cabinet body portion 106 (discussed hereinbelow with respect to FIG. 2). Front panel 110 may be flanked on vertical sides by cabinet side panel extensions 146 which serve to define a space below player interaction area 112 for players to place their feet and legs while they are playing the gaming system 100 in a seated position. Foot rest 148, which may be cushioned, is provided below player interaction area 112 to enhance a player's ergonomic comfort while playing the gaming system 100. In some implementations, the edges of player interaction area 112 may be ergonomically cushioned as well.

The gaming system 100 may be embodied in alternative gaming device housing forms and styles. For example, the housing may have fewer or greater number of display areas for displaying the game and game-related information to the player. If multiple displays are used, the displays may be of similar size, shape, and orientation or the displays may be divergent from each other in one or more of their respective descriptive characteristics. The one or more displays can be supported by, mounted upon, or housed within a cabinet 104 which can comprise a variety of shapes, sizes, and forms. The cabinet 104 can 1) protect and house the operational electronics, 2) adequately support the display(s) in a position easily viewable for a seated or standing player, as necessary, and/or 3) provide an easy location and support for all necessary player input/output (I/O) interactions, including gaming control interactions and value wagering interactions. For example, in some implementations the gaming system 100 may be disposed in a housing style referred to as a “slant top” gaming device that is designed to be operated with the player comfortably seated. In this arrangement, generally, the gaming display(s) and all player I/O controls are located on a low, wide, surface that extends forwardly from the player on a horizontal plane and then slopes upwardly and away from the player's seated location.

In some implementations, housing styles of cabinet 104 of gaming system 100 may include bar top or table top housing arrangements. These housings are generally small enough to be placed on top of an existing bar or table while providing the requisite gaming device housing functions of protection of/access to gaming electronics, displays, and player I/O functions described above.

In some implementations, cabinet 104 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

FIG. 2 illustrates a functional block diagram of a control unit 200 of a gaming system (e.g., gaming system 100) configured to perform specialized game functions and operations, consistent with the embodiments described herein. The functional elements shown in FIG. 2 cooperate, on a broad and general level, to function as a gaming system. The subject matter and functional operations described in relation to FIG. 2 can be embodied in hardware, software, or a combination thereof. Described hardware includes the structures described and their functional or operational equivalents. Described functions may be performed by hardware, digital circuitry, computer software, computer firmware, or functionally equivalent combinations thereof.

In accordance with aspects of the present disclosure, the control unit 200 is specifically configured and functions to perform all aspects of operations for providing the game. Control unit 200 includes at least one specially configured processor and at least one controller configured to operate with at least one memory device and at least one data storage device, at least one input device, and at least one output device. In one implementation, the control unit 200 is also configured to communicate with a server device through a network.

In some implementations, the control unit 200 includes at least one processor 202 (e.g., a central processing unit (CPU)). In some implementations, the processor 202 is specially configured with arithmetic logic units and math co-processors, also known as floating point units, for performing the gaming consistent with the various implementations disclosed herein. In some implementations, the specially configured processor 202 includes registers for holding instructions or other data, and cache memory for storing data for faster operation thereupon. In some implementations, the specially configured processor 202 may be a multi-core processor that includes two or more processors for enhanced performance, more efficient parallel processing, or other advantageous computing functions. In another implementation, the specially configured processor 202 may be one or more processing devices such as microprocessor(s) or integrated circuit(s) and may include one or more controllers. It should be appreciated that in some implementations, a general-purpose processor could be programmed to perform the functions of the specially configured processor 202.

A controller, in some implementations, is a device or a software program that manages or directs the flow of data between two entities. Often, controllers are special purpose circuitry or software that solve a technical communications problem between different technology systems. In some implementations, a controller functions as an interface between two systems while managing the communications between the systems. In another implementation, a controller functions as an interface between a processor and a peripheral device and functions to control the peripheral device.

At least one specially configured processor 202 or controller of control unit 200 may be specially configured to communicate with at least one memory device 204, generally shown as memory device 204 in FIG. 2. In some implementations, the memory device 204 includes one or more memory structures for storing instructions and various types of game data. The memory structures include one or more random access memory units (RAMs) units, one or more read only memory units (ROMs), one or more flash memory units including solid state drives (SSDs), one or more electrically erasable/programmable read only memory units (EEPROMs).

It should be appreciated that in some implementations, communication with the memory device 204 by the specially configured processor 202 or a controller, encompasses the processor or controller accessing the memory device 204, exchanging data with the memory device 204, or storing data to the memory device 204.

The memory device 204 may store all program code and game code (collectively the “code”), and operation data necessary for the operation of the control unit 200 providing a gaming device and execution of the gaming features described hereinbelow. In an alternative implementation, game code and operation data necessary for the operation of the control unit 200 may be stored in a distributed manner such that some code is stored in memory device 204 and other code is stored remotely from the control unit 200. In some implementations, the code and operation data necessary for the operation of the control unit 200 includes, for example, basic input and output function data, instruction fetching data, bus and network communication protocol data, and like data necessary for an operational gaming device. In some implementations, the code and operation data necessary for the execution of the gaming features includes, for example, game image data, game rule data, pay table data, game mode and timing data, gaming value and wager parameter data, and random or pseudo-random number generation data.

In addition to the memory device 204 described above, in some implementations, the code and operation data for the operation of the gaming device described above may be stored in removable game cartridges or flash drives, a compact disk ROM, a digital versatile disk (DVD) optical storage technology, or suitable other fixed non-transitory storage mediums. In another implementation, part or all of the code and operational data for operation of the gaming device or for execution of the game features may be stored in a remote memory structure and be downloaded to the memory device 204 via a network connection.

In some implementations, the control unit 200 may utilize any combination of memory devices such as random access memory devices (RAMs), unalterable memory devices (ROMs), and mass storage devices for securely storing and securely communicating the software components or code that facilitate game play and other functions of the control unit 200. The memory devices may store software components or codes that include various game data and game related control and execution software. In some implementations, the software components stored in the memory devices 204 may include gaming system initialization software, system basic input and output software, operating system software, value acceptor software, value dispenser software, display image generation software, game symbol set image generation software, game rule execution software, game data set(s), random number generation software, system driver software, system data bus management software, audio generation and speaker driver software, and video generation and display driver software, and any other suitable software routines for operation of the control unit 200.

In some implementations, memory devices, such as memory device 204, with the software components and other data may be secured and authenticated by authentication software stored in an unalterable memory device within the housing of the control unit 200. The control unit 200 may also include application specific integrated circuits (ASICs) to perform the security and authentication functions. At any appropriate time, such as before each play of a game, at a predetermined interval, upon transfer of any game data or any software components from a mass storage to the memory device 204, or upon demand, the control unit 200 (using a processor such as processor 202 or a separate ASIC) may execute an authentication routine and perform an authentication of any software component or other data of the control unit 200. In some implementations, the gaming device software components may be prepared for authentication via creation and storage of an encrypted signature unique to one or more of the software components.

In some implementations, an encrypted signature may be created by utilizing a hash function on a software component or code to form a message digest (i.e., a hash of the software component) followed by a key encryption of the message digest to form an encrypted signature unique to the software component. In some implementations, the key encryption may be public key encryption, private key encryption, or any suitable key encryption schema. The encrypted signature may be stored with the gaming device software component, for example, in a mass storage device or an unalterable memory. During a software component authentication, the gaming system 100 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and the control unit 200 may allow game play to proceed. However, when the message digests do not match, the control unit 200 may determine that the software component under authentication may be corrupted or fraudulent and game play may be halted. It should be appreciated that the control unit 200 may perform other suitable security and authentication checks on the game data or software components. Such authentication and security devices and functions are unique to gaming and casino industry to minimize or prevent fraud in gaming devices and gaming systems.

For a player to interact with a gaming device, the control unit 200 receives and processes player inputs, and the control unit 200 causes processed results to be output or communicated to the player. In some implementations, player inputs are recognized and processed or directed for processing by input/output (I/O) controller 206. Further, I/O controller 206 may process and direct player outputs for communication to the player. The I/O controller 206 can function as the intermediary between the specially configured processor 202 and one or more input devices to control information and data flow therebetween. I/O controller 206 may also function as the intermediary between the specially configured processor 202 and one or more output devices to control information and data flow therebetween. I/O controller 206 is configured to understand the communication and operational details (such as hardware addresses) for the attached input devices and output devices. In this manner, specially configured processor 202 is freed from the operational details of the peripheral I/O devices. For example, in some implementations where an input or output device is changed or upgraded, the I/O controller 206 can be changed without changing other gaming system components.

In some implementations, a player deposits value into a gaming device by inserting some form of currency into a value acceptor 208 for game play. Alternatively, a player deposits value into a gaming device by inserting an encoded paper ticket into a value acceptor 208 for game play in some implementations. The value acceptor 208 can be combined with a currency reader and validator, and a code reader for reading value encoded on paper tickets. The value acceptor 208 may read, validate and communicate the amount of the inserted value to the specially configured processor 202. Specially configured processor 202 can establish a gaming credit balance for the player based on the communication from the value acceptor 208. Specially configured processor 202 can also communicate the player's credit balance on a credit balance display of gaming system 100. During game play, the specially configured processor 202 processes a player's wagers and determines the amount of credits to debit from the player's credit balance. When a winning outcome is obtained, the specially configured processor 202 is configured to determine the amount of credits to add to the player's credit balance.

As previously mentioned with respect to FIG. 1, a variety of value acceptance arrangements are possible. In some implementations, the value acceptor 208 could include magnetic strip or chip card readers to accept and transfer value. The value acceptor 208 may also be configured to accept and transfer non-traditional currencies such as digital currencies. In these implementations, I/O controller 206, a specially configured processor 202, or both contain appropriate control instructions to communicate and extract value from the inserted item containing value. In some implementations, use of a magnetic strip or embedded chip card, for example a bank card, for value insertion requires the specially configured processor 202 to communicate, via network interface controller 224 (described below), with devices external to a gaming device.

In some implementations, a card reader 210 may be included in gaming system 100 to accept player loyalty cards. For example, card reader 210 can extract account identifying information from the card and utilizes this information to access the associated account information stored remotely via network interface controller 224. In implementations where player loyalty/player tracking systems are employed, a player's loyalty account and record of gaming activity can be stored in a networked storage location or database. The specially configured processor 202 is configured to record the player's gaming activity in memory device 204 during the duration of loyalty card insertion. When the loyalty card is removed from card reader 210, recorded gaming activity is uploaded, via network interface controller 224, to the remote storage location associated with the player's account. In this manner, the player's gaming activity can be further processed and analyzed, and the player can be awarded loyalty rewards based upon his activity data.

In various implementations, a player control 212 receives a player's game inputs and communicates the player's game inputs to the specially configured processor 202. The player's game inputs may include, but are not limited to, wager amounts, pay line selections, game control signals, and cash-out signals. The player control 212 may generate signals based on button presses, touch screen activations, or voice control. The player-initiated signals are propagated to the specially configured processor 202 by the I/O controller 206. Further, the player-initiated signals may direct and inform execution of the game instructions stored in the memory device 204 and configured to be executed by the specially configured processor 202.

In some implementations, the specially configured processor 202 is configured to execute stored program code and instructions which generate random numbers or pseudo-random numbers. In some implementations, as illustrated in FIG. 2, a random number generator (RNG) 214 is a software module configured to be executed by the specially configured processor 202 for the generation of a true random or pseudo-random number. The code for RNG 214 may be stored in the memory device 204. The RNG 214 generates random numbers for use by the gaming software during game execution. In some implementations, random numbers are utilized by game software for the random selection of one or more game symbols from a set of game symbols during a game. As a non-limiting example, the set of game symbols can include numbers, letters, geometric figures, symbols, images, character, animations, blank symbols (e.g., the absence of symbols), or any other suitable graphical depiction. In various implementations, once random symbols are selected based upon the random number generated by the RNG 214, patterns of symbols are compared to determine wagering outcomes. In an alternative implementation, gaming system 100 may include a hardware based random number generator that is in communication with specially configured processor 202 to supply random numbers for game generation purposes. The hardware based random number generator may be incorporated into specially configured processor 202 or can be separate from specially configured processor 202.

In yet another implementation, the random generation of “numbers” or symbols may be performed with electro-mechanical components. For example, gaming devices such as gaming system 100 may incorporate mechanical reels rotatable about a common axis. Indicia or symbols may be positioned around the periphery of the reels. The indicia or symbols on the reels may indicate separate detectable reel stop positions. The reels can be set into a spinning/rotation motion by pulling a lever or pushing a button. In some implementations, the gaming system 100 can stop the reels by a gaming device actuating, on a random timing basis, a suitable mechanical or electro-mechanical reel brake. When the reels stop rotating, one or more displayed stop positions of the reels are detected. Since the stop positions are associated with respective indicia or symbols, the gaming device can determine whether the combination of stop positions (i.e., translating to a combination of displayed symbols) results in a winning symbol combination.

Returning to FIG. 2, the control unit 200 controls the function and output of an output devices utilized by a gaming device. In various implementations, I/O controller 206 serves as an interface unit between specially configured processor 202 and output devices such as video processor 216, cabinet lighting controller 218, audio controller 220, and value dispenser 222.

In some implementations, the video processor 216 communicates with specially configured processor 202 to render all game graphics, video displays, and information on one or more video display units (e.g., displays 120, 130, and 134). In some implementations, the video processor 216 includes one or more processors, controllers, and/or graphics cards for processing the game images, outcomes, and animated displays and coordinating the processed data to be display between, among, or across any or all display devices. In various implementations, this may include being configured to simulate objects and the movement of objects which represent video reels containing sets of gaming symbols.

It should be appreciated that in certain other implementations where physical mechanical reels are utilized by the gaming system 100 as a game displays, reel controllers and stepper motors would be provided in lieu of or in addition to video processor 216.

In implementations which utilize cabinet lighting as described with respect to FIG. 1, a cabinet lighting controller 218 may be utilized to coordinate and control the color and timing of cabinet lighting displays with specially configured processor 202. In certain implementations which utilize sound design, specially configured processor 202 may utilize audio controller 220 to coordinate and control the sound emissions. In some implementations, audio controller 220 may include one or more audio processing cards for generating sound and for driving the one, two or more speakers that may be included with a gaming device.

In various implementations, players may collect remaining credit value by initiating a signal via player control 212 which is communicated to specially configured processor 202 via I/O controller 206. The signal triggers a readout of the player's credit amount and specially configured processor 202 initiates a value dispensing signal which, in turn, is communicated to value dispenser 222. In some implementations, value dispenser 222 can be controlled to issue the player's credit value using any of the types of value discussed herein. In some implementations, the player's credit value may be issued to the player via a printed and dispensed encoded paper ticket or token which the player can then exchange at a special purpose kiosk or cashier location for the monetary value encoded into the ticket or token. In some implementations, the specially configured processor 202 can direct the value dispenser 222 to issue to the player an appropriate amount of coin or bills directly to the player. Additionally, or alternatively, in some implementations, the player may have the option to electronically direct the credit value to an account associated with the player.

In some implementations, the control unit 200 may communicate with one or more devices outside the gaming device. For example, gaming system 100 may be connected to a larger network 240 via a local area network (LAN) or a wide area network (WAN). The control unit 200 may communicate with one or more central servers, controllers, or remote devices to execute games, establish credit balances, participate in jackpots, etc. In such implementations, network communications and connections are accomplished via a network interface controller 224. Network interface controller 224 can be a digital circuit board or card installed in control unit 200 to provide network communications with external devices.

In some implementations, various additional features and functions are performed by the control unit 200. For example, the control unit 200 may be specially configured with appropriate software to track all game play events that occur on a gaming device. In some implementations, the control unit 200 may audit all recorded monetary transactions, including all wager amounts, game outcomes, game winnings, and game payouts that occur through the value dispenser 222. Further, some implementations may include security software to assist in protecting the gaming system 100 from tamper or alteration attempts.

### Gaming System Operation

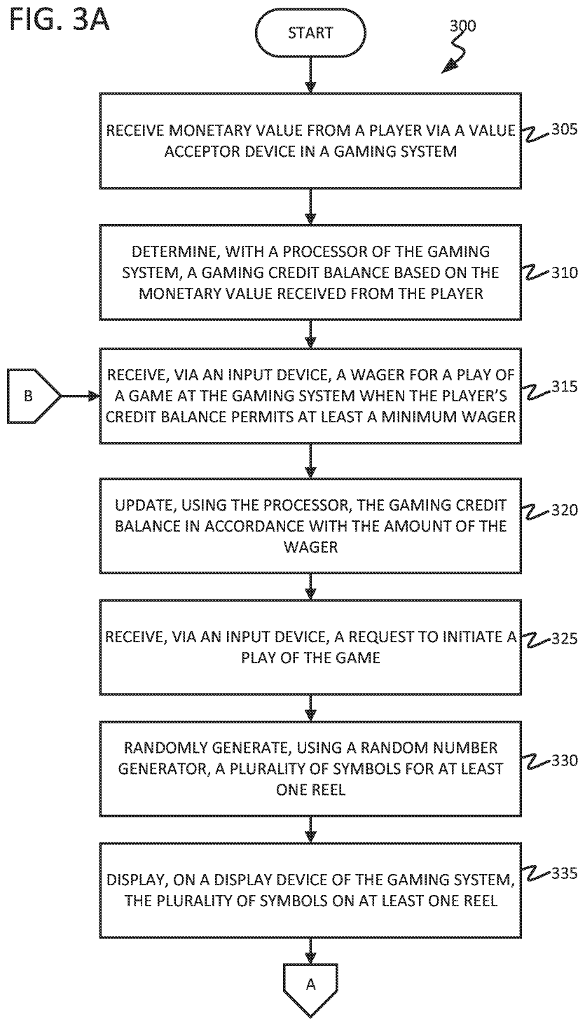

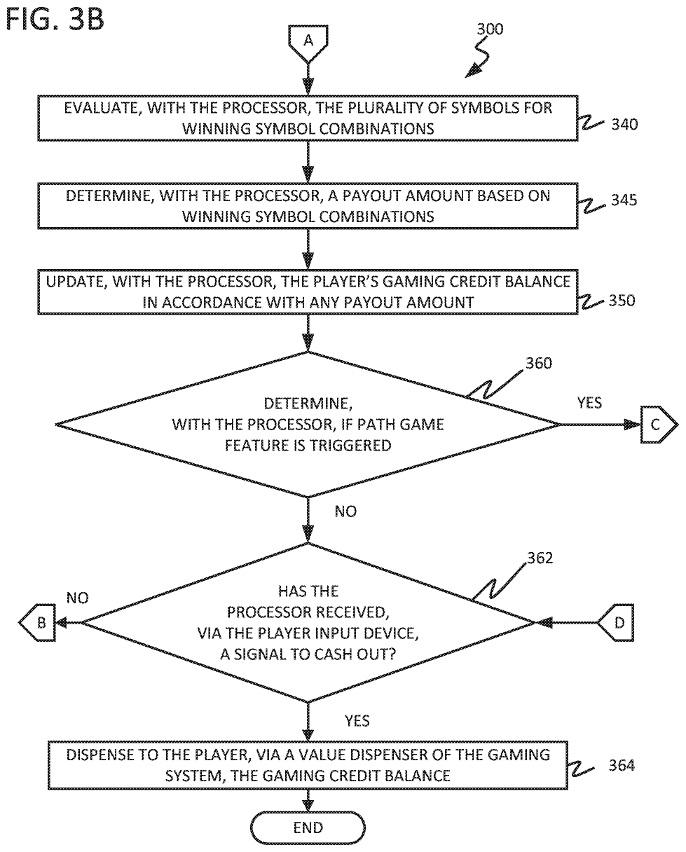

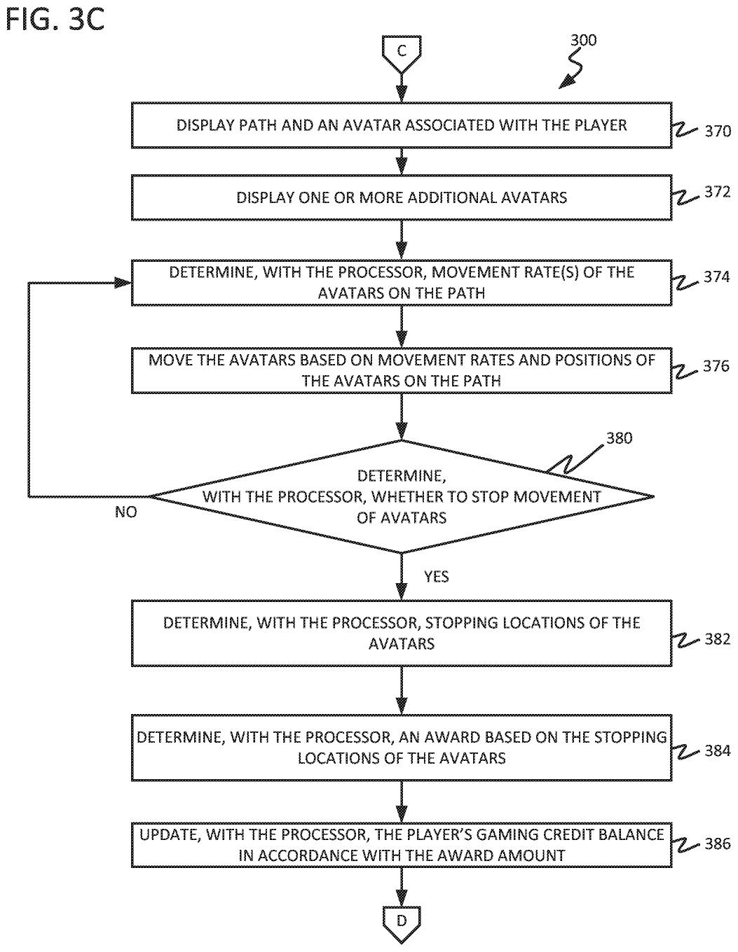

The flowcharts in FIGS. 3A-3C illustrate functionality and operation of possible implementations of systems, devices, methods, and computer program products according to various implementations of the present disclosure. Each block in the flow diagrams of FIGS. 3A-3C can represent a module, segment, or portion of program instructions, which includes one or more computer executable instructions for implementing the illustrated functions and operations. In some alternative implementations, the functions and/or operations illustrated in a particular block of the flow diagram can occur out of the order shown in FIGS. 3A -3C. For example, two blocks shown in succession can be executed substantially concurrently, or the blocks can sometimes be executed in the reverse order, depending upon the functionality involved. It will also be noted that each block of the flow diagram and combinations of blocks in the block diagram can be implemented by special purpose hardware-based systems that perform the specified functions or acts, or combinations of special purpose hardware and computer instructions. In some implementations, the flowcharts can include more blocks or fewer blocks.

FIGS. 3A-3C show a process flowchart illustrating an example of method 300 of operating the gaming system (e.g., gaming system 100) providing a path game feature in accordance with aspects of the present disclosure. FIGS. 3A-3C describe parts of a path game feature related to a video-based slot machine base or primary game. However, it should be understood that the gaming system may include the path game feature in a spinning slot machine reels base or primary game or may use the path game feature with a different type of base game. Furthermore, the gaming system may use the path game feature with another bonus game, such as selectively triggering one of the path game features or other bonus game feature based on symbols displayed during a base game.

In some implementations, one or more processors (e.g., processor 202) of the gaming system are configured, via instructions stored in a memory device (e.g., memory 204 or a storage system), to perform the method 300. In block 305, the gaming system receives monetary value via a value acceptor device (e.g., value acceptor 208). In block 310, the gaming system determines a credit balance based on the monetary value received from the player in block 305 at the value acceptor device. In block 315, the gaming system receives a wager for a play of a game from a player via an input device (e.g., player controller 212) using, e.g., the credit balance determined at block 310.

In some implementations, the gaming system allows the player to place a minimum wager, a maximum wager, or any suitable wager amount. In some implementations, the player's wager amount may determine the value of some of the available awards. Depending on the wager amount, the gaming system may also enable the player to select pay lines across displayed symbol positions (e.g., symbol display areas) on reels in a game in which to place wagers. Although in some implementations, the gaming system selects the wagered pay lines automatically based on the player's wager. Wagered pay lines may be referred to herein as active pay lines. In some implementations, the gaming system determines whether the credit balance determined at block 315 includes enough credits to enable the player's selected wager. The gaming system may prevent the player from placing the wager and starting a play of a game if the player's credit balance is not large enough to support the player's selected wager. If enough credits are not available in the player's credit balance, the gaming system enables the player to insert additional value to obtain the minimum credit level or to cash out of the gaming system. At block 320, the gaming system updates the credit balance determined at 310 in accordance with the amount wagered at 315.

At block 325, the gaming device receives a request to initiate a play of a base game via the input device. For example, the player may press a spin button on the gaming system to start spinning slot machine reels of the gaming system for a play of the game. In some implementations, a play of a game begins with a wager and activation of a game and the play of the game ends when the base game, the path game feature, or both have completed (depending on whether the path game feature is played). In another implementation, one play of a game comprises the processor executing blocks 315-386 and terminating at either block 360 or 362 depending on whether the gaming system activates the path game feature. In some implementations, block 362 and block 364 are not part of a play of a game. In alternative implementations, block 362 and block 364 are part of a play of a game.

It should be appreciated that reels or slot machine reels used throughout the specification may refer to mechanical reels, electro-mechanical reels, or virtual video reels (where virtual reels strips or no reel strips are used). It should further be appreciated that although many examples illustrated in the specification describe the games in terms of slot machines with reels, other games may be used, including games without slot machine reels.

At block 330, the gaming system randomly generates, using a random number generator (e.g., random number generator 214) game symbols for at least one reel of the gaming system from a first symbol set.

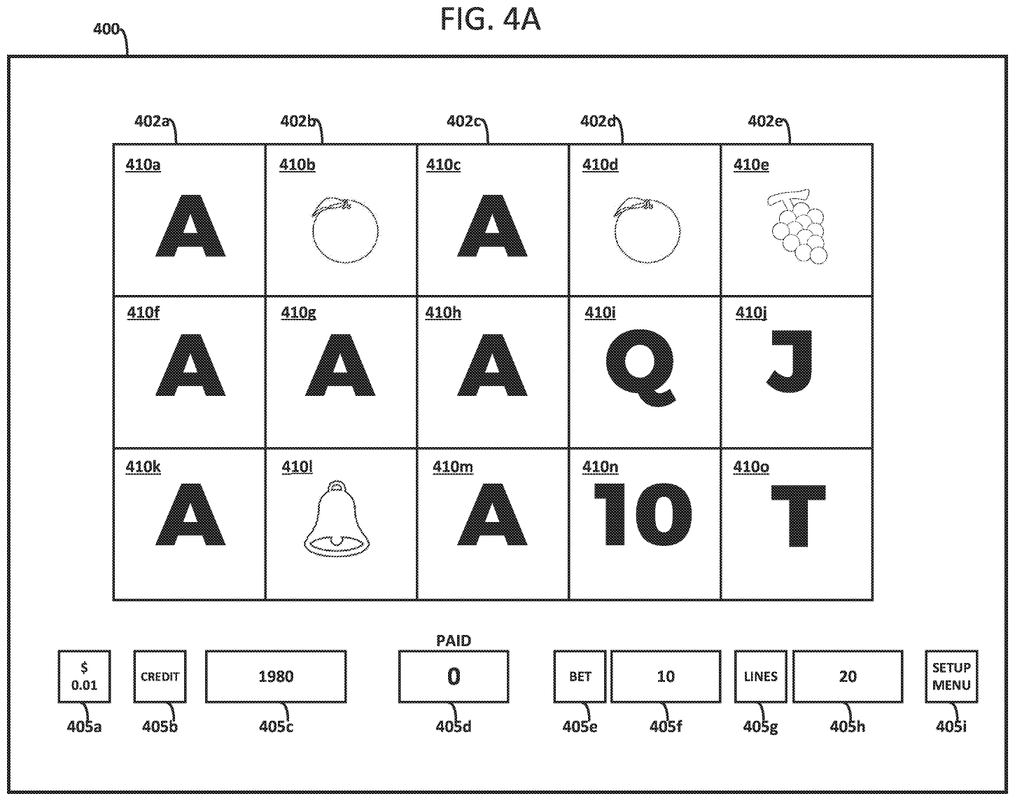

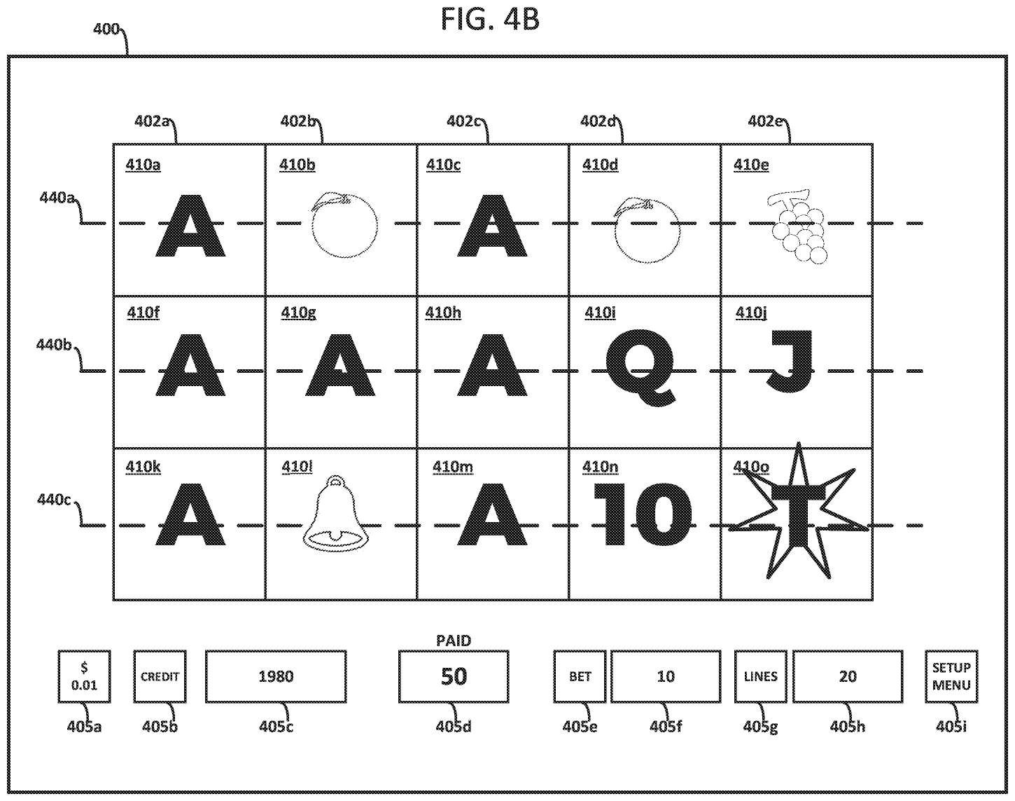

In some implementations, the gaming system may generate symbols for display on at least one reel (e.g., reel 402a in FIG. 4A). In some implementations, the gaming system may generate the symbols for display on a set of reels (e.g., reels 402a-402e in FIG. 4A). In some such implementations, the reels are associated with respective sets of symbols. At block 335, the gaming system causes a display device (e.g., first display device 120) to display the symbols generated at 330. For example, in a game using reels, the gaming system may display the generated symbols in visible symbol display areas of the individual reels.

Turning now to FIG. 3B, as indicated by off-page connector A, at block 340, the gaming system evaluates the displayed symbols for winning symbol combinations. In some implementations, gaming system evaluates the displayed symbols across active or wagered pay lines for winning symbol combinations. In some implementations, the gaming system evaluates the winning symbol combinations based on the pay lines (e.g., pay lines 440a-440c in FIG. 4B) wagered upon by a player. The gaming system may evaluate the player selected pay lines, gaming system assigned pay lines, or pay lines assigned as active in some other manner for the play of the game. In some implementations using reels, the gaming system determines an award amount based on winning symbol combinations formed across the reels on active pay lines. For example, if a pay table associated with the gaming system indicated that at least three of the same bar symbols is a winning symbol combination and awards a predetermined payout, the gaming system would evaluate the generated symbols for bar symbols. If the gaming system generated at least three bar symbols on adjacent reels and along an active pay line, the gaming system may determine that the three bar symbols is a winning symbol combination based on the predetermined pay table. It should be appreciated that a pay table may include any suitable number of winning symbol combinations and payouts. In some implementations, a pay table may indicate that as few as one symbol may be associated with a payout. Alternatively, two or more symbols may be used to form winning symbol combinations that result in a payout.

At block 345, the gaming system determines a payout amount based on the winning symbol combinations across wagered pay lines evaluated at block 340. At block 350, the gaming system updates the player's gaming credit balance in accordance with the payout amount determined at 345. As noted above, the blocks illustrated in FIGS. 3A-3C can be rearranged in any suitable order. As such, it should be appreciated that the gaming system may update player's gaming credit balance at other suitable times.

In some implementations, as indicated in block 360, the gaming system determines whether a path game feature is triggered. In some implementations, the gaming system evaluates the displayed symbols for at least one triggering symbol or for at least one triggering symbol combination of predetermined symbols that triggers the path game feature. It should also be appreciated that in some implementations, events other than generating one or more of a predetermined symbol or other symbol combinations may trigger the path game feature. For example, the gaming system may include or be in communication with a bonus controller, and the bonus controller may randomly determine or determine based on a predetermined triggering event (e.g., a quantity of games played) to trigger or active the path game feature.

Where the gaming system determines that the path game feature is triggered, the gaming system may execute the path game beginning at block 370, as indicated by off-page connector C. Alternatively, when the gaming system determines that a bonus game is not triggered, in block 360, operation 300 moves to block 362. In some implementations, as indicated in block 362, the gaming system may receive a request or a signal to end game play or “cash out” via an input device of the gaming system (e.g., which would end the gaming session). In such a situation, the gaming system dispenses a value to the player, through a value dispenser, based on the player's gaming credit balance as illustrated in block 364 and operation 300 ends.

If the gaming system processor has not received a signal to end game play (e.g., the player continues a gaming session to play another play of the game) via the player input device, the process of operation 300 returns to block 315, as indicated by off-page connector B. The gaming system may receive, via a player input device, a wager for another play of the game and continue operation 300 from block 315. However, in some implementations, the wager may not be accepted if the player has fewer credits than the player's selected wager amount, as shown in block 315.

Turning now to FIG. 3C, as indicated by off-page connector A, at block 370, the gaming system displays a path and at least one avatar associated with a player. The gaming system may position the avatar over or adjacent to one or more sections of the path. In some examples, the path may have a looped or rectangular shape, such that the avatar can move around the path one or more times. In some implementations, the path game may resemble a board game, and the game system may initially position the avatar based on the board game. For example, the path may have a beginning section and an end section, and the gaming system may initially display the player's avatar at this beginning section.

In block 370, the gaming system may display the avatar to be visually distinguishable from the path, such as displaying the avatar with a distinctive shape, image, and/or color. For example, the gaming system may display the avatar as having a rounded shape, such as an oval, and the sections of the path as having a substantially square or rectangular shape. In some implementations, the gaming system may size the avatar to correspond to a size of one of the sections of the path. For example, the avatar may be sized to fit in one section of the path or to overlap two adjacent sections of the path. In some implementations, the avatar may resemble a board game piece, such as a vehicle, an animal, or some other suitable object. In some implementations, the gaming system may display the avatar with text, an image, or other visually distinctive feature identifying an associated player. In some implementations, the gaming system may vary the appearance of the avatar based on a received user input, such as to allow the user to select between different images, shapes, colors, text, etc. for the avatar. In some implementations, the gaming system may display sections of the path in any suitable shape (e.g., square, round, rectangular, triangular, etc.).

In block 370, the gaming system may associate different sections of the path with different awards and may display information identifying the respective awards associated with the sections of the path. In some implementations, the displayed awards associated with certain sections of the path may be modified based on the player's actions during a current or prior play, an award from a prior play of a game, etc. For example, the gaming system may increase the displayed awards in the path game feature based on an award from a base game, based on a wager by the player, etc. In some implementations, certain sections of the path can be used to modify a movement of the avatar, such as causing the avatar to move to a different section of the path (such as moving the avatar forward given number of sections of the path or to return to the start of the path) or to change a movement rate of the avatar. Certain sections of the path may relate to special awards, such as an award that accumulates over multiple plays of a base game or the path game feature, or bonuses, such as a free spins or free games, providing the player within another avatar on the path, moving the avatar to a winning position on the path (e.g., causing the player's avatar to go to the end of the path), and the gaming system may display information on the path identifying these special awards. In some implementations, the gaming system may also display payout amounts associated with at least some of the special awards in a central region of the path. In some implementations, the path game feature may include awards or special awards static jackpots or progressive awards.

At block 372, the gaming system may display one or more additional avatars. The gaming system may display the different avatars with different shapes, colors, images, and/or text. For example, each avatar may include text identifying an associated player or a computer's avatar. In some implementations, the gaming system may provide the path game as a racing game in which the avatars compete against each other, for example, to move to a particular end section of the path or to cover a particular distance along the path. The avatars may have different movement speeds, starting points along the path, ability to win different awards, etc. The movement rates of the avatars may vary based on, for example, a quantity or frequency of plays of a base game, an action by the player in a base game or the path game feature, wagers by the player, sections of the path contacted by the avatars, etc., or based on other suitable criteria.

At block 372, in some implementations, one or more of the avatars may be associated with gaming system's computer (e.g., a non-playing character or CPU avatar). In some implementations, the gaming system at block 372 may display two or more avatars associated with a player. For instance, the game system may display one or more additional avatars associated with a player as an award in the path game feature or a base game, when a player's first avatar moves into a particular section of the path, an additional wager is received, etc. In some implementations, the gaming system at block 372 may display avatars associated with two or more players. In some implementations, the additional avatars for a player are provided for the duration of the path game feature. In some implementations, the additional avatars for a player are provided for a shorter duration of time than the path game feature. For example, in some implementations, the gaming system provides the additional avatars for a player for a predetermine quantity of additional plays of a base game. The predetermined quantity of additional plays of the base game can be three or any other suitable quantity. The gaming system may communicate with one or more other gaming systems to provide the path game feature for multiple network linked gaming systems, such as displaying avatars associated with different players in a tournament in a single screen displaying the path game feature. In alternative implementations, the gaming system may communicate with one or more other gaming systems to provide the path game feature for multiple network linked gaming systems, such as displaying avatars associated with different players in a tournament on a second screen displaying the path game feature of at least two or more of the network gaming systems participating in the tournament.

At block 374, the processor may determine respective movement rates of the one or more displayed avatars along the path. For example, each of the avatars may move along the path at the same or different movement rates. The game system may determine that an avatar passing through a certain number of sections or along a given length on the path per unit of time, per user action, or per play of the game.

At block 374, the gaming system may vary the movement rate of the player's avatar based on, for example, a quantity or frequency of plays of a base game, an action by the player in a base game or the path game feature, wagers by the player, etc. Additionally or alternatively, the movement rate determined at block 374 may vary based on one or more sections of the path through which the avatar passes. In some implementations, the movement rate for an avatar determined at block 374 may decrease to zero (e.g., stop) such that the avatar does not move during a time period or may become negative such that the avatar changes movement direction and returns to a previously passed section of the path.

In some implementations, the processor at block 374 may determine the movement of a player's avatar along the path based on one or more of the symbols displayed in the display areas associated with a base game. For example, the gaming system may evaluate the generated and displayed symbols in a base game to identify symbols or combinations of symbols causing an avatar to move along the path. In some implementations, the speed of movement of avatars along the path are predetermined at some point before or during a play of the path game feature. In some implementations, the processor at block 374 may randomly determine the speed of movement of avatars along the path. In some implementations, the processor at block 374 may randomly determine different speeds of movement for different avatars along the path. It should be appreciated that the speeds of movement can be determined at any suitable time.

At block 376, the gaming system may automatically move the one or more avatars along the path based on the movement rates and the positions of the avatars on the path, such as moving the avatars through a given number of sections per turn or per unit of time. In some implementations, a movement and/or a position of an avatar may affect a movement and/or position of another avatar. For example, a computerized avatar and/or an avatar associated with a first player may function as an obstacle, and the gaming system may prevent a second player's avatar from entering and/or passing a section of the path occupied by the CPU avatar or the avatar for the first player. In another example, the gaming system may allow an avatar (e.g., the player's avatar) to enter a section of path occupied by another avatar (e.g., the CPU avatar) and “bump” or displace that other avatar, such as moving the other avatar to another section of the path (e.g., back to a starting section) or removing the bumped avatar from the path.

In some implementations, the path game may resemble a board game, and at block 376, the gaming system may display the avatar as moving along or otherwise repositioned on the path to simulate the board game. For example, at block 370, the game system may initially position the avatar at a starting section of the path and, at block 376, may subsequently move the avatar along the path and towards an ending section of the path. In some implementations, the path may have a rectangular or other closed loop shape, and the gaming system may display the avatar as traveling around the path multiple times.

At block 380, the processor may determine whether to stop the movement of the avatar(s). For example, the processor may end the path game feature, for example, after a certain time period, after one of avatars reaches a particular section of the path (e.g., an end section), after one of avatars travels a particular distance on the path, a stop instruction is received from an administrator, a stop instruction is generated during a base game, or some other suitable triggering event. In some implementations, the path game feature may end when a movement rate of the player's avatar falls below a given level or stops. If the processor determines to continue moving one or more of the avatars, the process 300 returns block 374, where the processor determines whether to change the movement rate of the avatars on the path. In some implementations with multiple avatars, the gaming system may cause one or more of the avatars to stop at different times. Thus, in some implementations, when an avatar stops, the path game may continue based on the other avatars that have not reached a stopping point or stopping triggering event has not occurred for such other avatars. In some implementations with multiple avatars, when one avatar stops, the gaming system also stops one more of the other avatars. In some implementations with multiple avatars, when one avatar stops, the gaming system also stops all of the other avatars.

If the processor determines to stop moving one or more of the avatars in block 380, the processor determines the stopping location of an avatar on the path at block 382, and the processor may determine an award based on the stopping location of the avatar at block 384. At block 384, the gaming system may evaluate respective stopping locations of one or more of the avatars to determine a payout amount associated with the stopping location of the avatars. In another example, the gaming system at block 384 may determine one or more of the players to be winners based on the respective movements of the respective avatar, such as providing an award to the player associated with a first avatar to complete the path or providing an award to a player associated with an avatar that has reached the furthest point in the path.

In some implementations, the gaming system may vary the appearance of the avatar based on occurrences within the path game feature, such as to vary an image, shape, color, text, etc. for the avatar when the avatar has moved a given distance along the path or is positioned at a section of the path associated with an award.

At block 386, the gaming system updates the player's gaming credit balance in accordance with the payout amount determined at block 384. As noted above, the blocks illustrated in FIGS. 3A-3C can be rearranged in any suitable order. As such, it should be appreciated that the gaming system may update player's gaming credit balance at other suitable times. Process 300 may then return to FIG. 3B, as indicated by off-page connector D.

While not shown, the path game feature described in FIG. 3C (e.g., blocks 370-386) may run concurrently while one or more base games are being played. For example, the gaming system may continually execute blocks 315-360 (multiple different plays of the base game) while the gaming system may also execute the blocks in FIG. 3C. In some implementations, if a path game feature of 370 is triggered, the path game feature may be dependent on a player continuing to play additional plays of the base game. For example, when a player stops playing a base game linked to the path game feature, the gaming system may cause the path game feature to end (e.g., triggering a stop condition for the avatars). In some implementations, the path game feature may be triggered and run independently from a base game. In one such implementation, the path game feature may run with CPU avatars until a player at a base game obtains a triggering condition to add a player avatar to the path game feature.

FIGS. 4A and 4B show pictures of a gaming system display illustrating an example based on video slot machine reels in accordance with aspects of the present disclosure for type of base game. More specifically, FIGS. 4A and 4B illustrate screen shots of one implementation of a gaming system displaying video-based slot machine reels to obtain awards or to trigger a path game feature to obtain enhanced awards. FIG. 4A illustrates one implementation of a game screen 400 that the gaming system 100 may display on a display device of the gaming system. In some implementations, game screen 400 may be displayed on first display 120 of gaming system 100 illustrated in FIG. 1. However, any other suitable display may be used. The game screen 400 displays a set of a virtual video slot machine reels 402a, 402b, 402c, 402d, and 402e as illustrated in FIG. 4A for a primary or base game. As also illustrated in FIG. 4A, the reels 402a-402e are displayed substantially side by side. It should be appreciated that reels 402a-402e can be displayed with any suitable amount of separation or no separation. It should be appreciated that the game shown in game screen 400 is merely representative and may have more or fewer game elements (e.g., reels, symbol display areas, symbols, etc.) shown in the game screen 400. It should also be appreciated that other games may be used for the primary or base game.

In some implementations, the reels 402a-402e are each respectively associated with a set of symbols or a symbol set, where each set of symbols includes a number of symbols. The sets of symbols can be associated with the same or different symbols. The sets of symbols may include numbers, letters, geometric figures, symbols, images, character, blank symbols (e.g., the absence of symbols), animations, transparent symbols (e.g., symbols that permits underlying symbols to be visible), or any other suitable graphical depiction. The symbols in the set of symbols may include pay symbols and special or designated symbols.

In some implementations, at least one predetermined symbol is a triggering symbol for the path game feature. However, in some implementations, a path game feature is triggered in alternative ways. In one such alternative implementation, the path game feature can be triggered by a bonus controller in communication with the gaming system. In some implementations, at least one triggering symbol must be displayed on the reels during a play of a game to trigger the path game feature. In some implementations, any one of the symbols in the symbol sets can be designated as the predetermined triggering symbol. The triggering symbol may be associated with one function (e.g., triggering the path game feature), but may alternatively be associated with a plurality of different game functions. In certain examples described below, the triggering symbols includes a Trigger symbol, but is should be appreciated that other triggering symbols or triggering combinations of symbols may be used by the gaming system. In some implementations, the path game feature is always running, but the player may not obtain an avatar for the path game until a triggering event occurs in a base game.

Returning to FIGS. 4A and 4B, the game screen 400 depicts a plurality of symbol display areas (also referred to herein as symbol display positions) 410a, 410b, 410c, 410d, 410e, 410f, 410g, 410h, 410i, 410j, 410k, 410l, 410m, 410n, and 410o. The plurality of symbol display areas can be associated in a manner that provides the appearance of game or slot machine reels. It should also be appreciated that the symbol display areas may not be associated with game reels in some implementations. As illustrated in FIGS. 4A and 4B, symbol display areas 410a, 410b, 410c, 410d, 410e, 410f, 410g, 410h, 410i, 410j, 410k, 410l, 410m, 410n, 410o are associated in a manner that provides the appearance of a set of five slot machine game reels. In some implementations, the plurality of symbol display areas that provide the appearance of five game reels may be arranged in a manner that visibly shows three symbol display positions (e.g., symbol display areas) of each of the five game reels (e.g., visible stop positions on the reels). For example, the symbol display areas 410a-410o are each associated with positions on reels 402a-402e, respectively. As shown in FIGS. 4A and 4B, symbol display areas 410a, 410f, and 410k are associated with reel 402a; symbol display areas 410b, 410g, and 410l are associated with reel 402b; symbol display areas 410c, 410h, and 410m are associated with reel 402c; and symbol display areas 410d, 410i, and 410n are associated with reel 402d; and symbol display areas 410e, 410j, and 410o are associated with reel 402e. The gaming system may display fewer or more reels in various implementations.

The arrangement illustrated in the implementation of FIGS. 4A and 4B thus creates a visible display area of the reels 402a-402e having three visible symbol positions for each reel. When viewed together, reels 402a-402e appear as a 3-row by 5-column reel array in screen 400. In other implementations, smaller or larger visible areas of the reels may be displayed. That is, the reels 402a-402e may show fewer or a larger number of visible symbol display areas. In some implementations, some symbol display areas can be hidden to hold generated symbols for use when the reels are nudged, as is discussed herein. While symbol display areas are illustrated with defined boxes, it should be appreciated that in some implementations, the defined boxes are not visible to the player. It should also be appreciated that in some implementations, the symbol display areas are other shapes or not defined shapes and may not be associated with reels.

Each reel 402a-402e may display a plurality of symbols that the gaming system generates from the sets of symbols in their respective symbol display areas, as illustrated in FIGS. 4A and 4B. In some implementations, the individual reels may be shown spinning in one direction to simulate slot machine reels. However, it should be appreciated that the reels may be shown spinning in any suitable direction. The reels may also be shown spinning in different directions in some implementations. In some implementations, the gaming system does not depict reels or spinning symbols.

Game screen 400 also includes several information areas and buttons 405a-405i. These information areas and buttons 405a-405i are illustrated in an example configuration and positioning associated with a particular arrangement, but may be arranged in any suitable manner in different implementations. In some implementations, game screen 400 may include more or fewer display areas and buttons 405a-405i than illustrated. Information area 405a illustrates an example value of one credit for the game displayed in game screen 400, and in the example shown in FIGS. 4A and 4B, information area 405a illustrates a value of $0.01. Button 405b illustrates a software button that the player can select to view how many credits the player has accumulated and monetary value of these credits if the player wishes to cease playing (e.g., a product of a value per credit shown in information area 405a and a number of remaining credits shown in information area 405c. Information areas 405c illustrate an example of the amount of the player's available credits. In the example shown in FIGS. 4A and 4B, information area 405c illustrates that the player has 1980 available credits after placing a wager. Information area 405d illustrates the amount of credits a player has won. Because FIG. 4A illustrates an example display associated with a start of a play of a game, the information area 405d shows zero credits have been won during the play of the game.

Button 405e illustrates a software button that the player can select to place a bet or wager. It should be appreciated that the functionality of button 405e may also be replicated or replaced with a hardware button on the gaming system 100. Information area 405f illustrates that the player has selected to wager 10 credits per pay line. Button 405g illustrates a software button that the player can select to determine how many pay lines to wager on. It should be appreciated that the functionality of button 405g may also be replicated or replaced with a hardware button on the gaming system 100. Information area 405h identifies a number of pay lines on which the player chooses to wager, and in the example shown in FIG. 4A, information area 405h indicates that the player selected to wager on 20 pay lines. Button 405i illustrates a software button that the player can select to obtain information about the game, change certain aspects of the game, obtain help, place an order, etc.

To start a gaming session, a player provides the gaming system with a deposit of value, using one of the suitable mechanisms discussed above. The gaming system receives and validates the player's deposit of value. The gaming system can then issue credits (or gaming credits) to the player based on the received value. The credits enable the player to initiate a play of a game and to also place wagers on the play of the game. The gaming system may provide a visual indication of the player's credit balance to the player as discussed above in information area 405c.

To initiate the play of the game, the player activates or presses one or more appropriate buttons on the gaming system to deduct credits necessary to play the game and to identify the player's wager. Along with receiving the player's wager, the gaming system may receive pay line selections or other game functions the player wishes to activate in exchange for the wager. The player may also actuate a game start button, a spin button, or a lever (not shown). The gaming system may deduct the appropriate credits from the player's credit balance (e.g., in information area 405c) after the wager or at any suitable time. For example, the gaming system may deduct a wager per pay line in information area 405f multiplied by a number of pay lines in information area 405h.

Upon receipt of the player's wager and activation of the game start button, the gaming system may show a display of spinning reels for each of the reels 402a-402e. The spinning may appear to occur in a vertical top to bottom direction or in a vertical bottom to top direction (not shown), or in a combination of vertical directions (not shown). In some implementations, the gaming system randomly generates symbols from the associated sets of symbols for reels 402a-402e, respectively. As noted above, the gaming system may rely on random generation performed by a pseudo RNG, a true RNG, or hardware RNG specifically designed for gaming systems. In some implementations, the gaming system may also update the player's credit meter (information area 405c) to reflect the player's available credit balance. As shown in FIG. 4A, the player's credit meter (information area 405c) was decremented by 200 credits from 2180 to 1980 to reflect a prior 200 credit wager the player placed for the play of the game.

The gaming system displays the generated symbols in symbol display areas 410a-410o, as illustrated in FIGS. 4A and 4B. Symbols displayed on reels 402a-402e illustrate the randomly generated symbols from the symbol sets after the reels have stopped spinning. As illustrated in FIGS. 4A and 4B, the gaming system randomly generated and displayed symbols in symbol display areas 410a-410o for reels 402a-402e.

In the example illustrated in FIGS. 4A and 4B, the gaming system generated and displayed Ace symbols (“A”) in symbol display areas 410a, 410c, 410f, 410g,410h, 410k, and 410m; Orange symbols in symbol display areas 410b and 410d; a Grape symbol in symbol display area 410e; a Queen symbol (“Q”) in symbol display area 410i; a Jack symbol (“J”) in symbol display area 410j; a Bell symbol in symbol display area 410l; a 10 symbol in symbol display area 410n; and a Trigger symbol in symbol display area 410o in the game screen 400. It should be appreciated that the displayed symbol combinations are merely for explanatory purposes and the gaming system may randomly generate any suitable combination of symbols based on defined symbol sets associated with the reels 402a-402e.

In some implementations, the gaming system may evaluate the displayed symbols on reels 402a-402e for winning symbol combinations. As noted above, the player may have wagered on one or more pay lines (such as 20 pay lines shown in information area 405h). In some implementations, at least the active (e.g., the wagered on pay lines) are evaluated for winning symbol combinations. Any suitable number of pay lines may be used to evaluate winning symbol combinations.

In some implementations, the gaming system may evaluate the generated symbols on reels 402a-402e for triggering symbols or combinations of symbols that trigger the path game feature (hereafter referred to as “triggering symbol combinations”). As noted above, the player may have wagered on one or more pay lines (such as 20 pay lines shown in information area 405h). In some implementations, at least the active (e.g., the wagered on pay lines) are evaluated for triggering symbol combinations. Any suitable number of pay lines may be used to evaluate for the triggering symbol combinations.

In some implementations, the gaming system evaluates the displayed symbols for winning symbol combinations before evaluating the reels for triggering symbol combinations that trigger the path game feature. For example, the gaming system may provide the path game feature as an award in the base game, such as when the displayed symbols on reels 402a-402e correspond to one or more of winning symbol combinations. In another example, the gaming system may evaluate the displayed symbols for triggering combinations when based on determining that the displayed symbols on reels 402a-402e do not correspond to any of the winning symbol combinations (e.g., the path game feature may be triggered as a consolation award). In some implementations, the gaming system does not evaluate the displayed symbols for winning symbol combinations until after the reels have been evaluated for triggering symbol combinations that trigger the path game feature. For example, the gaming system may first evaluate the generated symbols for triggering symbol combinations and then evaluate the generated symbols for winning symbol combinations when the path game feature is not triggered.

In some implementations, the gaming system does not evaluate the displayed symbols for triggering symbol combinations that trigger the path game feature. For example, the gaming system may evaluate the displayed symbols for winning symbol combinations, and the gaming system may determine that the racing game feature is triggered whenever the displayed symbols correspond to one or more of winning symbol combinations. In other examples, the gaming system may determine that the path game feature is triggered based on other factors in addition to or unrelated to the displayed symbols. For example, the gaming system may determine that the path game feature is triggered based on receiving a user input (e.g., a user request received by one or more of the buttons) to request the path game feature. In some implementations, the gaming system may provide the path game feature when the player wagers on one or more pay lines. In other examples, the gaming system may include or be in communication with a bonus controller, and the bonus controller may randomly determine or determine based on a predetermined triggering event (quantity of games played) to trigger or active the path game feature. In some implementations, the gaming system may enable the player to pay or wager to activate the path game feature.

In the example shown in FIG. 4B, the gaming system evaluates the displayed symbols for winning symbol combinations and/or triggering symbol combinations in the wagered-on lines. In FIG. 4B, the gaming system may determine that reels with winning symbol combinations were displayed based on three Ace symbols appearing on certain wagered pay lines. For example, pay line 440b was an active pay line, and three Ace symbols were present along the pay line 440b in display areas 410f, 410g, and 410h. Furthermore, in the example shown in FIG. 4B, the gaming system may determine that the path game feature is triggered based on a particular symbol (e.g., the Trigger symbol in symbol display area 410o) appearing on one or more wagered pay lines. For example, pay line 440c is an active pay line, and the Trigger symbol is present along this pay line in display area 402o. In some implementations, the gaming system can evaluate trigger symbols as scatter symbols, thus, a gaming system may not require a trigger symbol be generated on an active pay line.

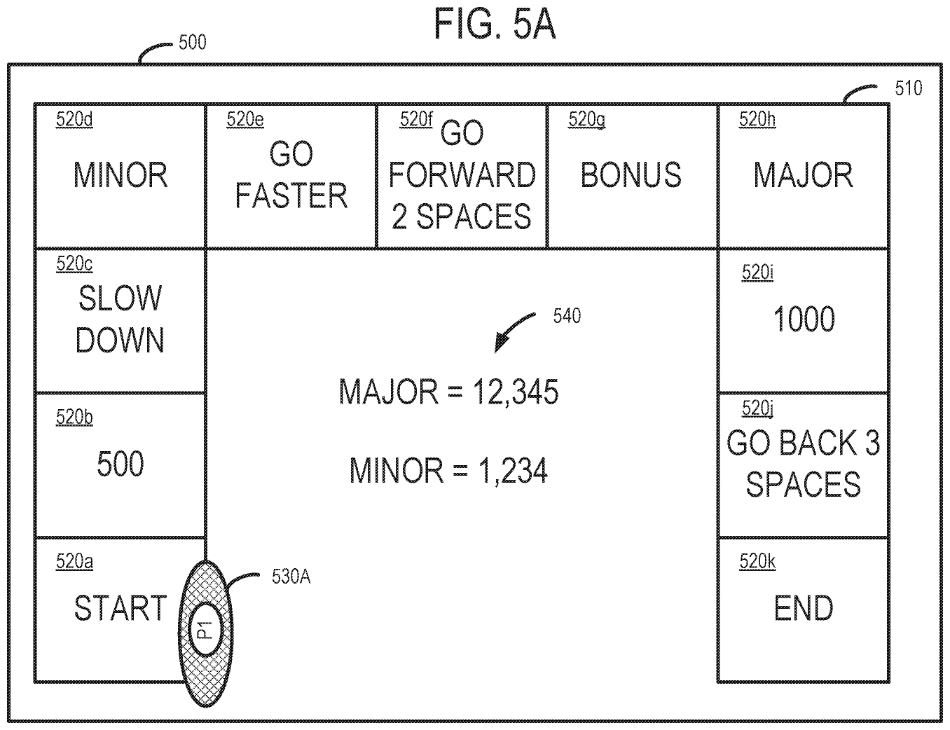

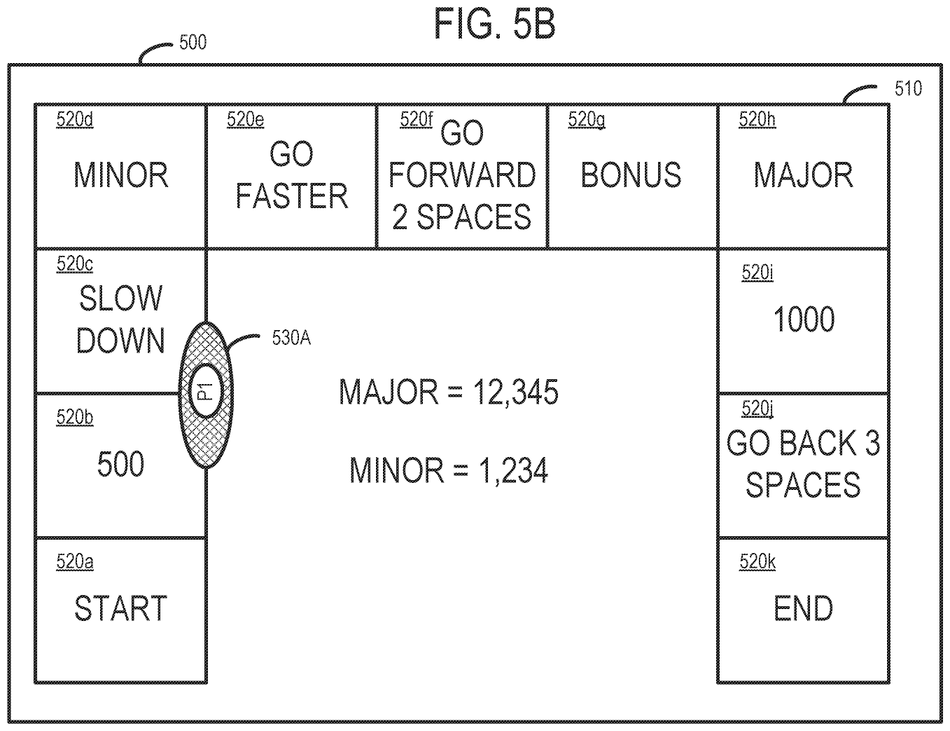

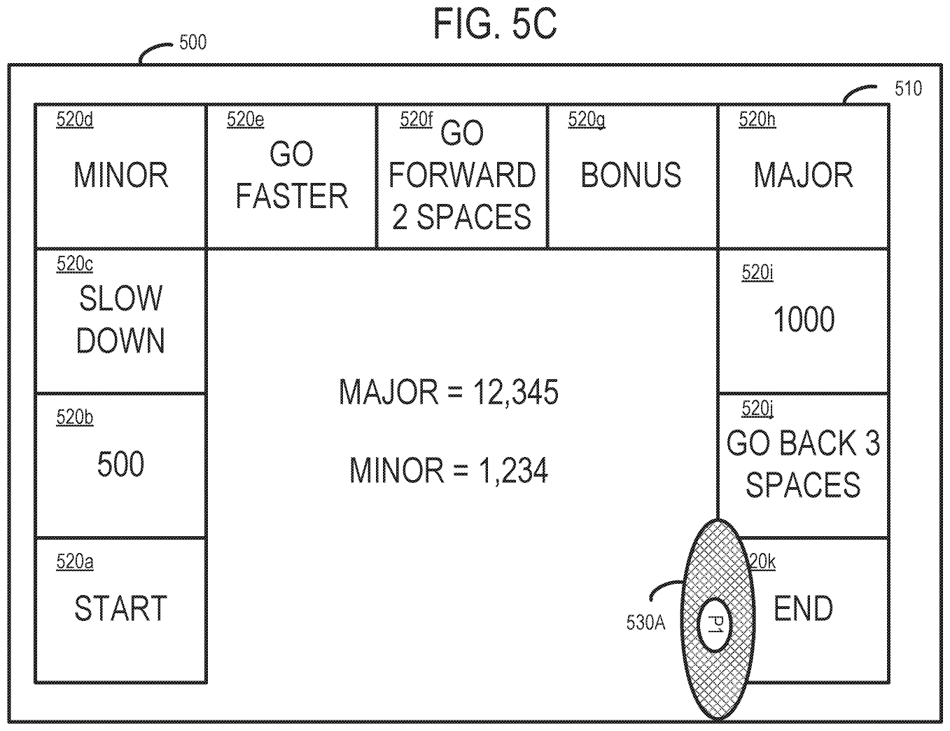

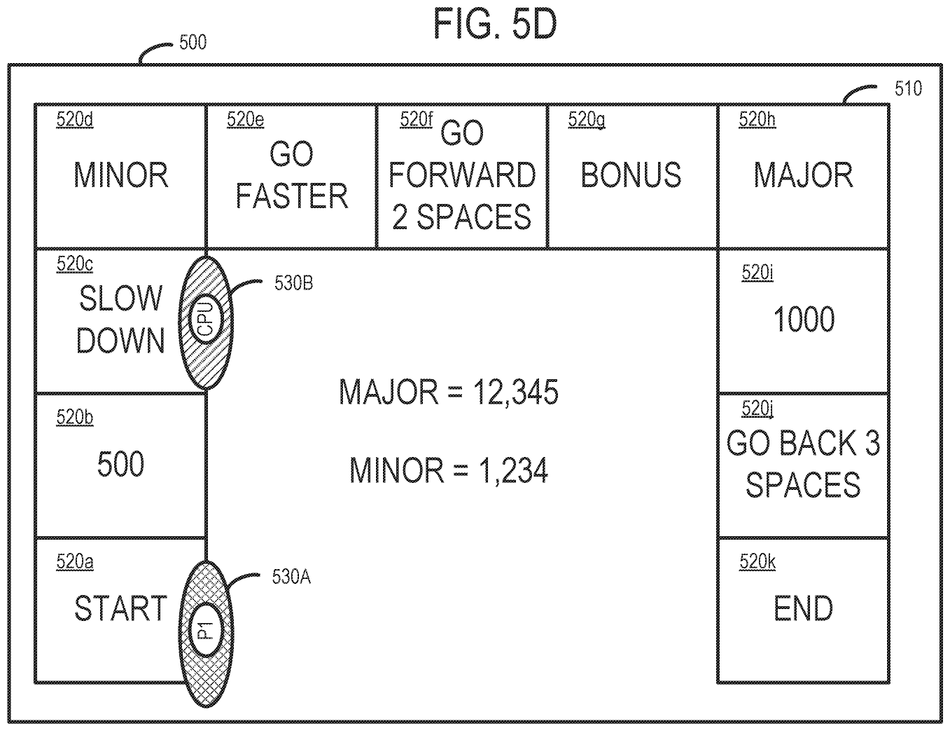

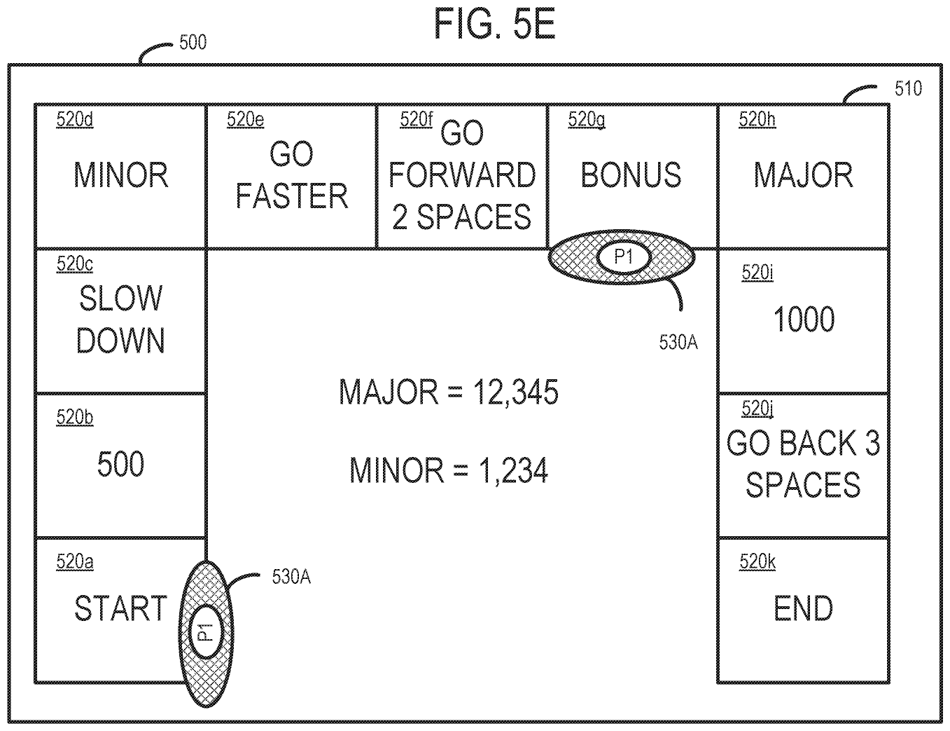

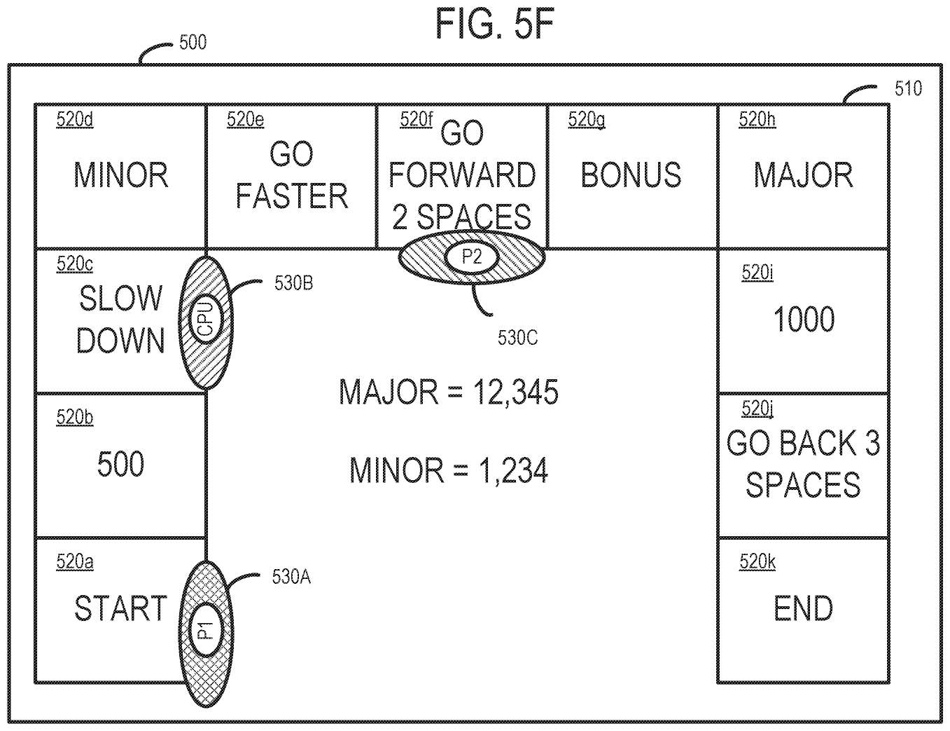

As also illustrated in FIG. 4B, the gaming system determines a payout amount for the play of the game based on the displayed winning symbol combinations of Ace symbols and an associated pay table (not shown). The gaming system may update the player's gaming credit balance (50 credits in 405d) in accordance with the calculated award amount. In some implementations, the play of the game ends. In some implementations, game system implements the path game feature (e.g., as described below with respect to FIGS. 5A-5F, 6A-6G, and 7) and may provide additional and/or different the awards based on the path game feature.

The player may continue the gaming session (e.g., another consecutive play of the game) by executing another play of the game. That is, the player may place another wager and start a new play of the game as noted above. However, continued game play is dependent of the number of credits remaining in the player's credit balance. The player may also choose to cash out. In such an instance, the gaming system provides the player a value based on the player's credit balance using any of the value items discussed above (bills, coins, vouchers, etc.).

FIGS. 5A-5F show pictures of a gaming system display illustrating a path game feature in accordance with aspects of the present disclosure. For the sake of brevity, FIGS. 5A-5F share features similar to the features already discussed above in connection with FIGS. 3A, 3B, 4A, and 4B and such similar feature will not be described again. FIGS. 5A-5F illustrate screen shots of one implementation of a gaming system that provides a path game feature. FIGS. 5A-5F illustrate certain implementation of a game screen 500 that the gaming system 100 may display on a display device of the gaming system. In some implementations, game screen 500 may be displayed on a second display 130 of gaming system 100 illustrated in FIG. 1. However, any other suitable display may be used. For example, when the path game feature is part of a networked gaming system with multiple gaming machines, the path game can be displayed on a central display to the multiple gaming machines.

The game screen 500 displays a path 510 that includes sections 520a-520k (referred to individually as a section 520 and collectively as sections 520) and one or more avatars 530A, as illustrated in FIG. 5A for the path game feature. The game screen 500 may also include an information area 540 providing information to the player, such as information identifying certain awards (e.g., “Major” and “Minor” awards associated with certain special game sections 520h and 520d, respectively). As also illustrated in FIG. 5A, the sections 520 may be displayed substantially side by side to combine to provide a continuous path 510. It should be appreciated that sections 520 can be displayed with any suitable amount of separation or no separation. It should be appreciated that the path game shown in game screen 500 is merely representative and may have more, fewer or different game elements (e.g., paths, sections, avatars, etc.) than those shown in the game screen 500. In some implementations, the path game does not have a defined start section or end section, and the path sections form a looping path.

In some implementations, at least some or all of the path sections 520a-520k may be associated with various text, images, symbols, etc. For example, section 520a identifies a “Start” position for a player's avatar 530A, and section 520k identifies an “End” of the path 510. Other path sections 520b, 520i identify particular awards (e.g. 500 and 1000), and paths sections 520d and 520h may identify special awards (e.g., a Major award and a Minor award identified in information area 540) that may be won by the player in the path game feature. Another section 520g may identify a “Bonus”, such as a free game, an additional avatar, slowing down a competing avatar, increasing the awards in the path game feature, etc. The Major and Minor awards may accumulate over multiple plays of the path game feature. In some implementations, the player may receive these awards when the avatar 530A moves through and/or stops at the path sections such as 520b, 520i, etc. As described below, the avatar 530A may be associated with a movement rate in which the avatar passes through a quantity of sections 520 per time period, per play, per wager, etc., and certain path sections 520c and 520e may alter the movement rate. Other sections 520f and 520i may change a location of the avatar 530A, such as to cause the avatar to move forward or backwards by a certain number of sections 520 along the path 510.

As shown in FIGS. 5A-5C, the gaming system 100 may position the avatar 530A over or adjacent to one or more sections 520 of the path 510. In some implementations, the path 510 may resemble a board game, and the gaming system may display the avatar 530A as moving along or otherwise repositioned on the path 510 to simulate the board game.

As shown in FIG. 5A, the gaming system 100 may initially display the player's avatar 530A at the Start section 520a. The gaming system 100 may then move the player's avatar 530A along the path 510 toward the End section 520k. In the path game feature, the gaming system 100 may determine, for example, when the avatar has traveled past a certain section 520 of the path (e.g., the End section 520k line), after a given length of time, after certain actions by the player, after a randomly determined triggering event, when a particular input is received from an administrator, etc. In some implementations, the gaming system 100 may evaluate a location of the avatar 530A (e.g., the section of the path 510 where the avatar 530A stopped) at the end of the play when determining an award.

As shown in FIG. 5A, the gaming system 100 may display the avatar 530A to be visually distinguishable from the path 510, such as displaying the avatar 530A with a distinctive shape, image, and/or color. As shown in FIG. 5A, the gaming system 100 may display the avatar 530A as having a rounded shape, such as an oval, and the sections 520 of the path 510 as having a substantially square or rectangular shape. In some implementations, the gaming system 100 may size the avatar 530A to correspond to a size of one of the sections 520 of the path 510. For example, the avatar 530A may be sized to fit in one section 520 of the path 510 or to overlap two adjacent sections 520 of the path 510. In some implementations, the avatar 530A may resemble a board game piece such as a vehicle, an animal, or some other suitable object. In some implementations, the gaming system 100 may display the avatar 530A with text, image, or other visually distinctive feature identifying an associated player. In FIG. 5A, the player's avatar 530A is designed with text “P1.” In some implementations, the gaming system may vary the appearance of the avatar based on a received user input, such as to allow the user to select between different images, shapes, colors, text, etc. for the avatar. For example, the input selecting the appearance of the avatar 530A may be received via an player input device 115 included in the control area 114.

In some implementations, the gaming system may vary the appearance of the avatar 530A based on occurrences within the path game feature, such as to vary an image, shape, color, text, etc. of the avatar 530A moving a given distance along the path 510 or positioned at a section 520 of the path 510 associated with an award. For example, as shown in FIG. 5C, the computing system may enlarge the avatar 530A that has reached an End section 520k.

In some implementations, the gaming system 100 may vary the displayed awards associated with certain sections 520 of the path 510 based on the player's actions during a current or prior play of a base game, an award from a prior play of the base game, etc. For example, the awards displayed in the sections 520 may increase based on an award from a base game (e.g., the slot machine base game shown in FIGS. 4A and 4B).

In some implementations, the gaming system 100 may cause the player's avatar 530A to have a movement rate, such as displaying the avatar 530A as passing through a certain number of sections 520 per unit of time, per user action, per play, etc. In some implementations, the movement rate is predetermined for the avatar 530A. In some implementations, the avatar 530A continues to move along the path 510 until player obtains a stop triggering condition in a related base game or reaches the End section of the path 510. The gaming system may award the player with an award associated with the section of the path 510 that the avatar 530A is on when the stop condition is triggered. In some implementations, if the section of the path 510 that the avatar 530A is on when the stop condition is triggered is not an award, but another game triggering event, the path game may resume and execute the game feature identified in the section of the path 510 that the avatar 530A is on (e.g., Slow Down in section 520c, Go Faster in section 520e, Go Forward 2 Spaces in section 520f, etc.).

In some implementations, as shown in the example shown in FIG. 5B, the gaming system 100 moved the avatar 530A from the Start section 520a to a position at which the player's avatar 530A contacts section 520b associated with an award of 500, and section 520c that causes the avatar 530A to Slow Down (e.g., reduce the movement rate). In one example, if section 520c causes the avatar 530A to sufficiently slow down such that the path game feature ends, the gaming system 100 may determine that the player receives an award of “500” due to the position of the avatar 530A in the award section 520b. In another example, the gaming system 100 may not award the player until another condition is met, such as the avatar 530A moving to the End section 520k, as shown in FIG. 5C. In some implementations, if the player reaches the End section 520k, the gaming system may provide the player with a consolation award. In other implementations, if the player reaches the End section 520k, the gaming system may provide the player with a Jackpot award. In some implementations, for the path game feature to continue (enabling the player's avatar to continue to move along the path), the player may be required to continue to place wagers and play additional plays of a base game.

The gaming system 100 may vary the movement rate of the player's avatar 530A. For example, the movement rate may vary based on a quantity or frequency of plays, an action by the player in a base game or the path game feature, wagers by the player, etc. In some implementations, the movement rate for an avatar 530A may decrease to zero (e.g., stop) such that the avatar 530A does not move during a time period or may become negative such that the avatar 530A changes movement direction and returns to a previously passed section 520 of the path 510. In some implementations, the path game feature may end when a movement rate of the player's avatar 530A falls below a given predetermined level or stops.

In one implementation, the gaming system may determine a movement rate of the avatar 530A based on combinations of symbols displayed in the reels 402a-402e of a base game, such as shown in FIGS. 4A and 4B. For example, the gaming system 100 may store a movement table (not shown) associating certain symbols and/or symbol combination with a movement of the avatar 530A. For example, the gaming system 100 may move the avatar 530A by a number of Ace symbols in symbol display areas along an active pay line 440c is that included a symbol (e.g., the Trigger symbol) triggering the path game feature.

As shown in FIG. 5D, the gaming system 100 may position one or more of the avatars 530B associated with a non-playing character (e.g., “CPU” or computer avatar) of the path 510. In the example shown in FIG. 5D, the CPU avatar 530B is positioned in front of the player avatar 530A. The gaming system 100 may display the CPU avatar 530B with different shapes, colors, images, and/or text in comparison to the player's avatar 530A. For example, the CPU avatar 530B may include text (“CPU” in FIG. 5D) identifying the avatar as not being associated with or controllable by the player.

The gaming system 100 may automatically move the CPU avatar 530B along the path 510, such as moving the CPU avatar 530 through a number of sections 520 per turn or per unit of time. In some implementations, a movement and/or position of a CPU avatar 530B may affect a movement and/or position of a player's avatar 530A. For example, the CPU avatar 530B may function as an obstacle, and the gaming system 100 may prevent the player's avatar 530A from entering and/or passing a section 520 of the path 510 occupied by the CPU avatar 530B. In another example, the gaming system 100 may allow an avatar to enter a section 520 of path 510 occupied by another avatar and “bump” or displace that other avatar. For example, the player's avatar 530A may enter a path section 520 occupied by the CPU avatar 530B and cause the CPU avatar 530B to be moved to another section of the path 510 (e.g., back to a starting section 520A) or be removed from the path 510.

In some implementations, the gaming system 100 may provide the path game feature as a racing game in which the player's avatar 530A and the CPU avatar 530B compete against each other, for example, to move to the End section 520k of the path 510 or to cover a particular distance along the path 510. The player's avatar 530A and the CPU avatar 530B may have different movement speeds, starting points, awards, etc. The movement rates of the avatars may vary based on, for example, a quantity or frequency of plays, an action by the player in a base game or the path 510 game feature, wagers by the player, etc. For example, an additional wager may cause the player's avatar 530A to increase in movement rate and/or cause the CPU avatar 530B to slow down. In some implementations, the gaming system assigns a predetermined movement speed to various displayed avatars and such avatars maintain such movement speeds for a predetermined time period or for the duration of a triggered path game feature. In some implementations with predetermined movement speeds, different avatars may not occupy the same section of the path 510 at the same time and the avatars may appear to chase each other for the duration of a triggered path game feature.

As shown in FIG. 5E, the gaming system 100 may display two or more avatars 530A associated with a player. For instance, the game system may display one or more additional avatars 530A associated with a player as an award in the path game feature or a base game, when one of the player's avatar 530A moves into a particular section of the path 510 (e.g., into bonus section 520g, as shown in FIG. 5E), an additional wager is received, an avatar triggering signal is generated or received at the gaming system, etc. The player's avatars 530A may move along the path 510 in the manner described above. In one example, the player may receive a sum of respective awards associated with the sections 520 of the path 510 corresponding to the stopping locations of the player's avatars 530A. In another example, the path game feature may function as a race, and the player may receive an award associated with an ending location of one of the player's avatars 530A that has moved furthest along the path 510. In yet another example, the player may select among the respective awards associated with the ending locations of the player's avatars 530A on the path 510.

As shown in FIG. 5F, the gaming system 100 may also display one or more avatars 530C associated another player. For example, the gaming system 100 may communicate with one or more other gaming system 100s to provide the path game feature over multiple gaming system 100s. As shown in FIG. 5F, the gaming system 100 may also display a CPU avatar 530B. The game systems may display avatars 530A and 530C associated with different players in a tournament. Each of the avatars 530A, 530B, and 530C for the different players and the CPU may move along the path 510 during the path game feature. In some implementations, the path game feature may end, for example, after a certain time period, after one of avatars reaches a particular section of the path 510 (e.g., End section 520k), after one of avatars travels a particular distance on the path 510, an ending signal is received or triggered, one or more of the gaming system 100 generating a stop triggering symbol or symbol combination, etc. The gaming system 100 may evaluate respective stopping locations of one or more of the avatars 530A, 530B, and 530C to determine a payout amount(s) associated with the stopping locations. For example, the path game feature may function as a race, and the gaming system 100s may determine one or more of the players to be winners based on the respective position or movement distances of the avatars 530A, 530B, and 530C on the path 510. In some implementations, the gaming systems provide one award associated with at least one player avatar for each player participating in the path game feature.

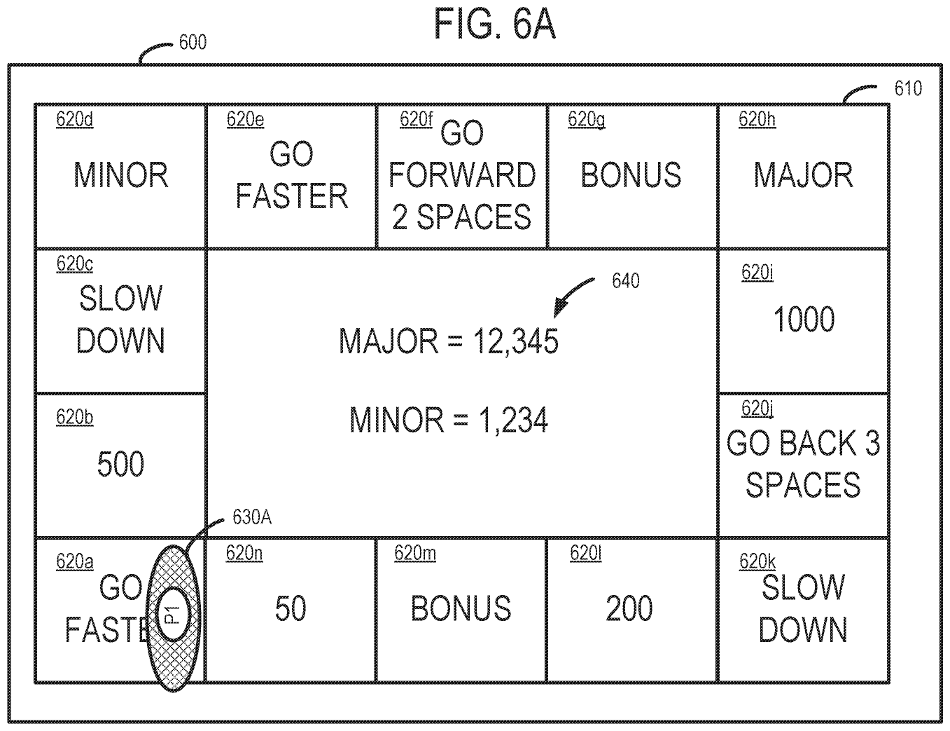

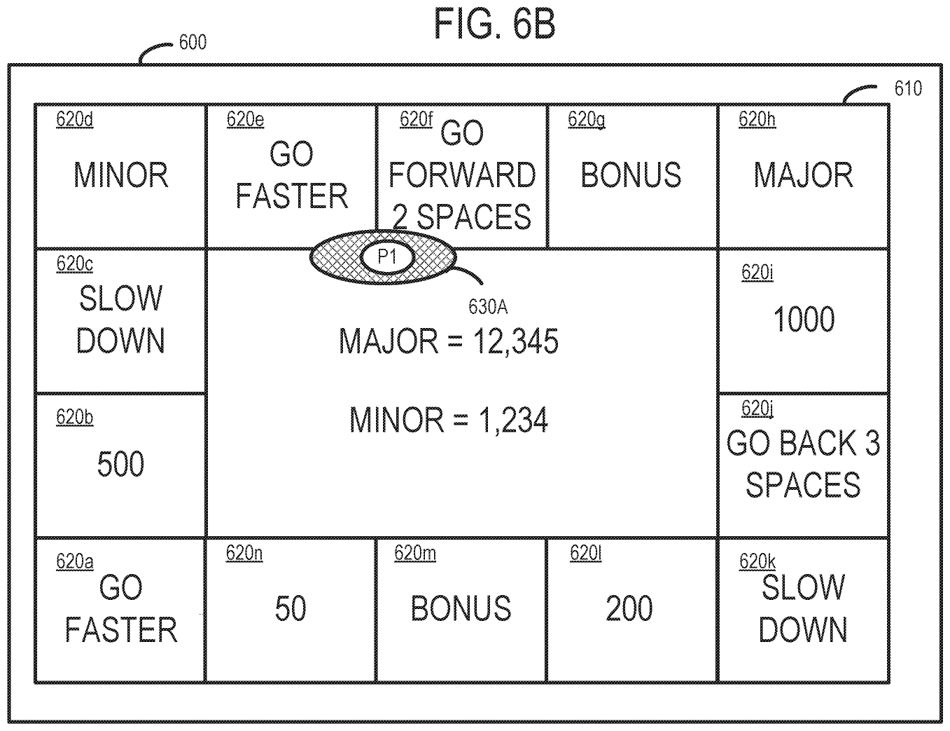

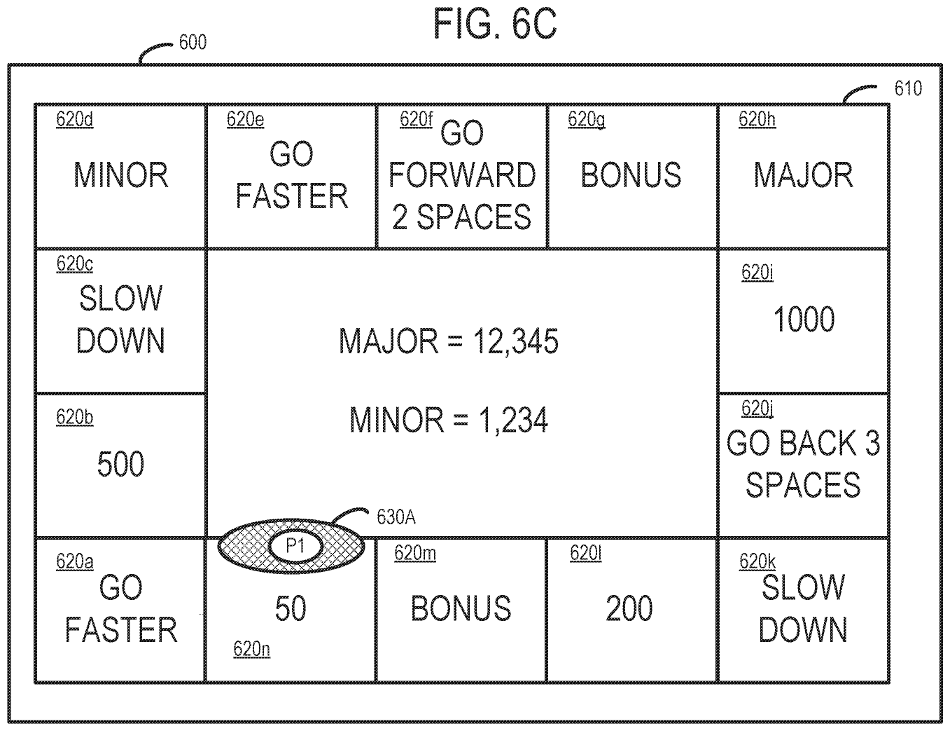

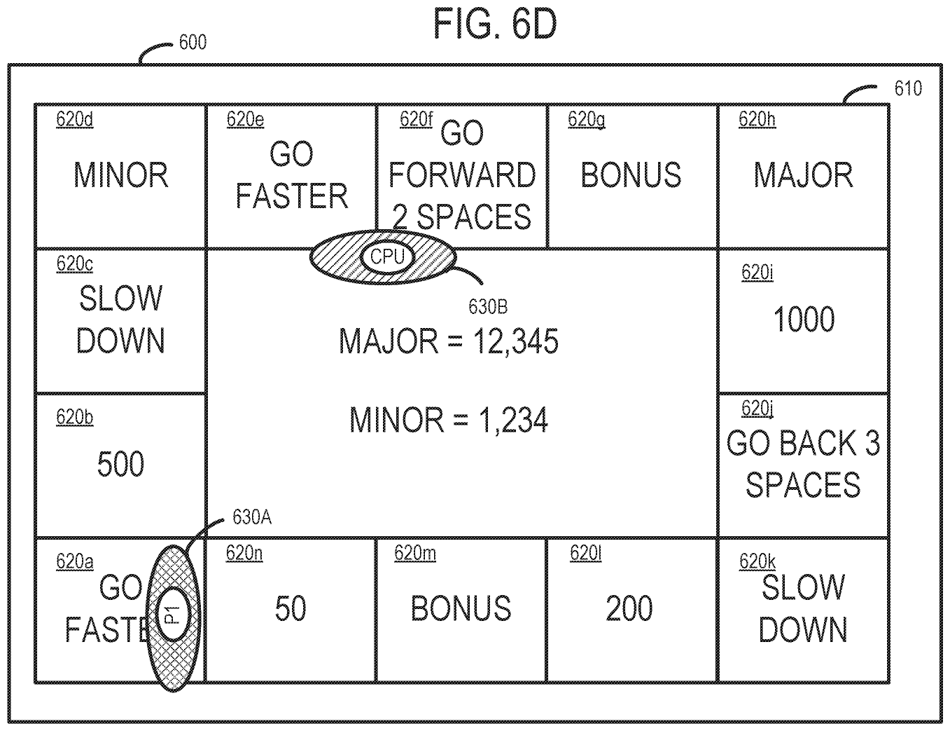

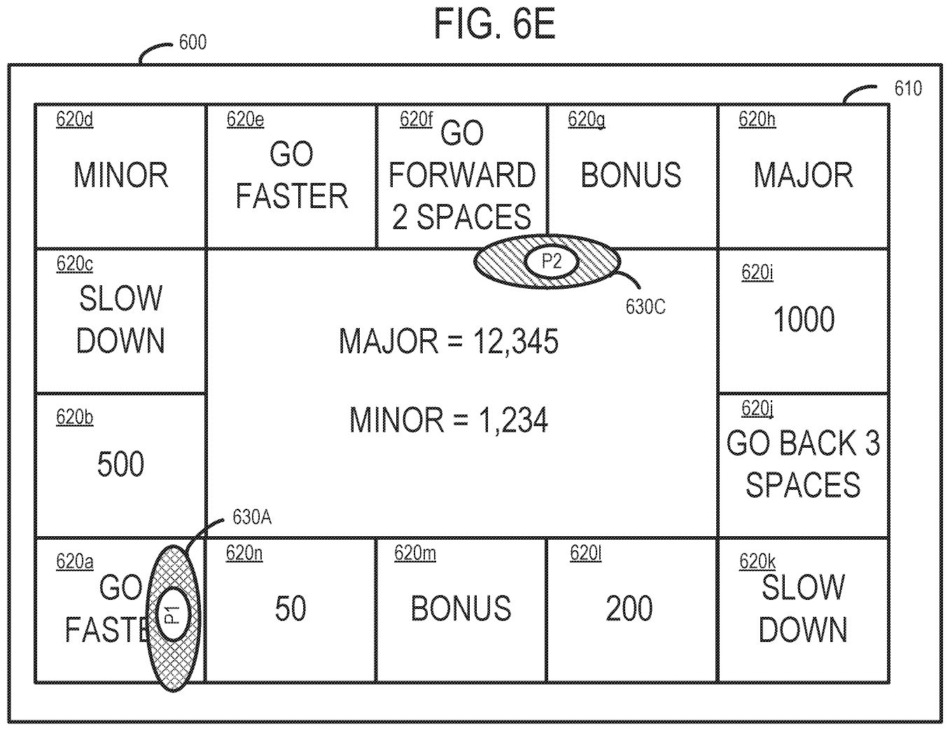

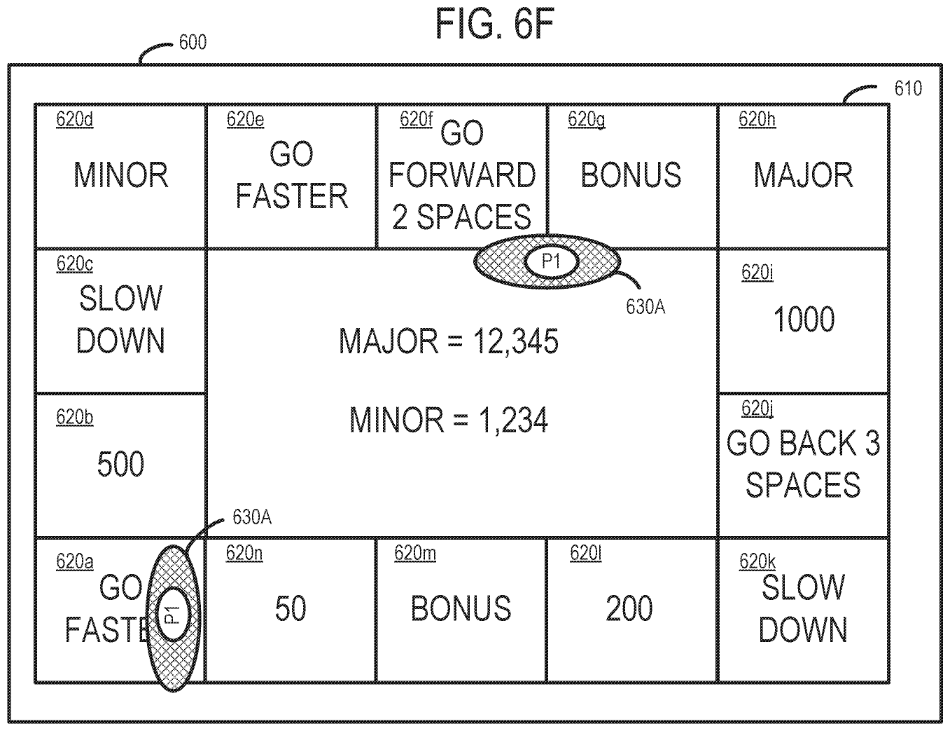

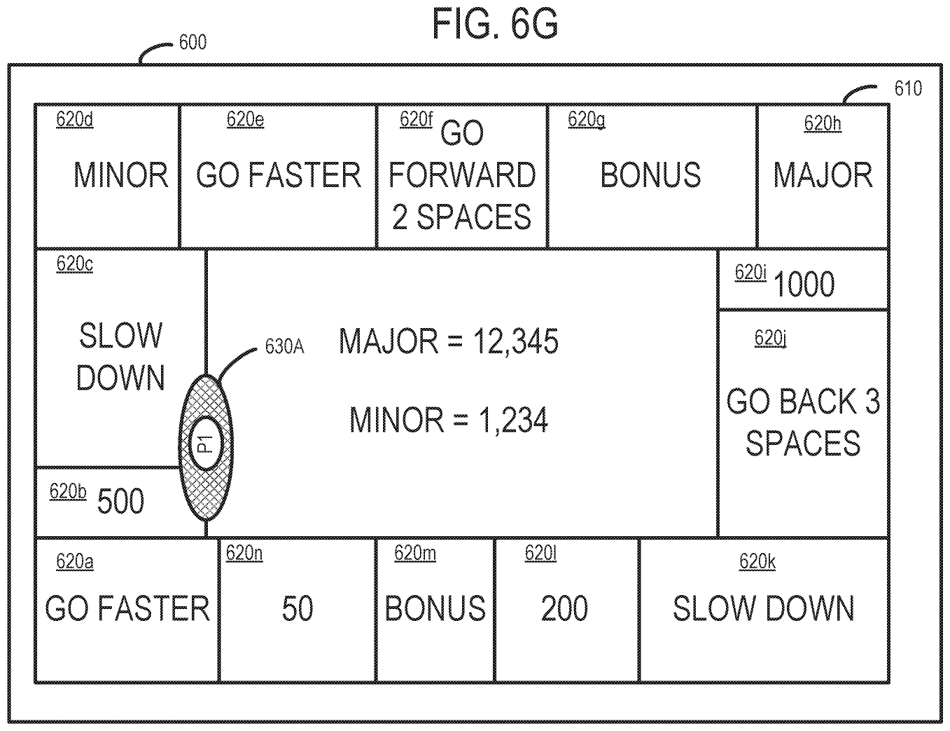

FIGS. 6A-6G show pictures of a gaming system display illustrating a path game feature in accordance with aspects of the present disclosure. For the sake of brevity, FIGS. 6A-6G share features similar to the features already discussed above in connection with FIGS. 3A, 3B, 4A, 4B, and 5A-5F and such similar feature will not be described again. FIGS. 6A-6G illustrate screen shots of one implementation of a gaming system that provides a path game feature. FIGS. 6A-6G illustrate certain implementation of a game screen 600 that the gaming system 100 may display on a display device of the gaming system. In some implementations, game screen 600 may be displayed on second display 130 of gaming system 100 illustrated in FIG. 1. However, any other suitable display may be used.

The game screen 600 displays a path 610 that includes sections 620a-620n (referred to individually as a section 620 and collectively as sections 620) and one or more avatars 630A, as illustrated in FIG. 6A for the path game feature. The game screen 600 may also include an information area 640 providing information to the player, such as information identifying certain prizes (e.g., “Major” and “Minor” prizes associated with certain special game sections 620h and 620d, respectively). As also illustrated in FIG. 6A, the sections 620 may be displayed substantially side by side to combine to provide a continuous path 610. It should be appreciated that sections 620 can be displayed with any suitable amount of separation or no separation. It should be appreciated that the game shown in game screen 600 is merely representative and may have more, fewer or different game elements (e.g., paths, sections, avatars, etc.) than those shown in the game screen 600.

In some implementations, each of the path sections 620a-620n may be associated with various text, images, symbols, etc. For example, path 610 may have a looped form, and the player's avatar 630A may be initially positioned in one of the sections 620. For example, the beginning location of the player's avatar 630A may be determined based on a generated result by the RNG and/or based on the combination of symbols displayed in the reels 402a-402e. In FIG. 6A, certain path sections 620b, 620i, 620j and 620n identify particular awards, and paths sections 620d and 620h may identify special awards (e.g., a Major award and a Minor award identified in information area 640) that may be won by the player in the path game feature. Other sections 620g and 620m may identify a “Bonus”, such as a free game, an additional player avatar 630A, slowing down a competing avatar (e.g., CPU 630B in FIG. 6D), increasing the awards in path sections 620b, 620i, 620j and 620n, etc. The Major and Minor awards may accumulate over multiple plays of the path game feature. In some implementations, the player may receive these awards when the avatar 630A moves through and/or stops at the path sections 620b, 620i. As described below, the avatar 630A may be associated with a movement rate in which the avatar passes through a quantity of sections 620 per time period, per play, per wager, etc., and certain path sections 620a, 620c, 620e, and 620k may alter the movement rate. Other sections 620f and 620j may change a location of the avatar 630A, such as to cause the avatar 630A to move forward or backwards by a certain number of sections 620 along the path 610.

As shown in FIG. 6A, the gaming system 100 may position the avatar 630A over or adjacent to one or more sections 620 of the path 610. In some implementations, the path 610 may resemble a board game, and the gaming system may display the avatar 630A as moving along or otherwise repositioned on the path 610 to simulate the board game. For example, the game system may initially position the avatar at section 620A and may subsequently move the avatar 630A along the path 610 in a particular direction (e.g., clockwise).

The gaming system 100 may determine a stop triggering condition for the path game feature or for a particular avatar, for example, when a player's base game generated a stop triggering symbol or stop triggering symbol combination, when the avatar has traveled past a certain section 620 of the path, after a given length of time, after certain actions by the player, after a randomly determined ending, when a particular input is received from an administrator, etc. In some implementations, the gaming system 100 may evaluate a location of the avatar 630A (e.g., the section 620 of the path 610 where the avatar 630A stopped) when gaming system generates a stop triggering condition (e.g., a predetermine symbol or symbol combination) in an associated base game. As noted above, any suitable stop triggering conditions can be used to stop avatar's movement.

In some implementations, the gaming system tracks the location of avatars in sections 620 of the path 610. By tracking the location of avatars along the path, the gaming system reduces the amount of evaluation that is necessary when a stop condition is triggered for the path game feature or a stop condition is triggered for a particular avatar in the path game feature. In particular, the gaming system may avoid evaluating each of the sections 620 of the path 610 for the location of an avatar, which helps the gaming system conserve processor and memory resources during an award evaluation process of the path game feature. For example, unlike a game with reels, whereby the gaming system must evaluate all of the displayed symbols for winning symbol combinations, the path game feature enables the gaming system to limit its evaluation to the section of the path that an avatar is located when the stop condition is triggered, which reduces processor and memory resources to ultimately determine an award associated with an avatar. By reducing the amount of game elements (e.g., sections 620 of the path 610) that are evaluated, the efficiency of the gaming system is improved because less memory and less processing power are used during the gaming system's determination of a bonus award from the path game feature over typical reel based bonus games. This machine efficiency also translates into faster game play because less time is used to complete a play of the game. When such efficiency improvements are made and applied to the hundreds and thousands of plays of the game that are made on a casino floor for the disclosed gaming system, the new gaming system will provide casino game operators sizable gains in gaming system efficiency, which is a technological improvement.

In some implementations, the gaming system 100 may cause the player's avatar 630A to have a movement rate, such as displaying the avatar 630A as passing through a certain number of sections 620 per unit of time, per user action, per play, etc. In the example shown in FIG. 6B, the gaming system 100 has moved the avatar 630A from the Start section 620a to a position at which the player's avatar 630A contacts section 620e that causes the avatar 630A to go faster (e.g., increase the movement rate). In one example, the avatar 630A sufficiently slows down such that the path game feature ends, the gaming system 100 may determine an award to the player based on the ending location of the avatar 630A and/or sections 620 passed by the avatar 630A before the path game feature stopped. For example, as shown in FIG. 6C, the player may receive an award of 50 based on the avatar 630A stopping in section 620n. Furthermore, when the avatar 630A passes section 620n, the avatar may continue on path 610, such as to revisit previously passed sections 620a. In some implementations, the gaming system may provide the player an award associated with one or more sections of the path that the player's avatar managed crossed by the time stop condition is triggered. In some implementations, the play of the path game feature can be altered based on a player's skilled input. For example, in some implementations where a player's speed of game play during plays of a base game influence the speed of an avatar, the player can attempt to control how fast the player plays the base game. Such player skill may be helpful when the gaming system causes the player's avatar to speed up based on other factors (as noted above), whereas the player wants to keep the player's avatar at a lower speed to increase the player's likelihood of obtaining a stop triggering condition when the player's avatar is on or near section 620h in some implementations.

In some implementations, the gaming system 100 may vary the movement rate of the player's avatar 630A. For example, the movement rate may vary based on a quantity or frequency of plays, an action by the player in a base game or the path game feature, wagers by the player, etc. In some implementations, the movement rate for an avatar 630A may decrease to zero (e.g., stop) such that the avatar 630A does not move during a time period or may become negative such that the avatar 630A changes movement direction (e.g., moves counter clockwise) and returns to a previously passed section 620 of the path 610. In some implementations, the path game feature may end when a movement rate of the player's avatar 630A falls below a given level or stops.

As shown in FIG. 6D, the gaming system 100 may position one or more of CPU avatars 630B, and the gaming system 100 may automatically move the CPU avatar 630B along the path 610, such as moving the CPU avatar 630 through a number of sections 620 per turn or per unit of time. As previously described, a movement and/or position of a CPU avatar 630B may affect a movement and/or position of a player's avatar 630A. For example, the CPU avatar 630B may function as an obstacle, and the gaming system 100 may prevent the player's avatar 630A from entering and/or passing a section 620 of the path 610 occupied by the CPU avatar 630B. In another example, the gaming system 100 may allow an avatar to enter a section 620 of path 610 occupied by another avatar and “bump” or displace that other avatar. For example, the player's avatar 630A may enter a path section 620 occupied by the CPU avatar 630B and cause the CPU avatar 630B to be moved to another section of the path 610 (e.g., back to a starting section 620A) or be removed from the path 610. In some implementations, the player may bump another avatar from the path with an additional wager, or based on obtaining certain symbols or symbol combinations in one or more plays of a base game. In another example, the player's avatar 630A may change direction (e.g., travel counter-clockwise) based on a positioning of the CPU avatar 630B of path 610.

In some implementations, the gaming system 100 may provide the path game feature as a racing game in which the player's avatar 630A and the CPU avatar 630B compete against each other, for example, to move to the End section 620k of the path 610 or to cover a particular distance along the path 610. The player's avatar 630A and the CPU avatar 630B may have different movement speeds, moving direction, starting points, awards, etc. The movement rates of the avatars may vary based on, for example, a quantity or frequency of plays, an action by the player in a base game or the path 610 game feature, wagers by the player, etc. For example, an additional wager may cause the player's avatar 630A to increase in movement rate and/or cause the CPU avatar 630B to slow down.

As shown in FIG. 6E, the gaming system 100 may also display one or more avatars 630C associated another player. For example, the gaming system 100 may communicate with one or more other gaming system 100s to provide the path game feature for multiple gaming system 100s at the same time (e.g., in a tournament). In some implementations, the tournament held for multiple local network connected gaming systems. In some implementations, the tournament held for multiple remote and local network connected gaming systems. The gaming system 100 may also display a CPU avatar 630B. The game systems may display avatars 630A and 630C associated with different players in a tournament. Each of the avatars 630A, 630B, and 630C for the different players and the CPU may move along the path 610 during the path game feature. In some implementations, the path game feature may end, for example, after a certain time period, after one of avatars reaches a particular section of the path 610, after one of avatars travels a particular distance on the path 610, an ending signal is received or triggered in a base game, etc. The gaming system 100 may evaluate respective stopping locations of one or more of the avatars 630A, 630B, and 630C to determine a payout amount(s) associated with the stopping locations. For example, the path game feature may function as a race, and the gaming system 100s may determine one or more of the players to be winners based on the respective position or movement distances of the avatars 630A, 630B, and 630C on the path 610.

As shown in FIG. 6F, the gaming system 100 may display two or more avatars 630A associated with a player. For example, in some implementations, the game system may display one or more additional avatars 630A associated with a player as an award in the path game feature or a base game, when one of the player's avatar 630A moves into a particular section of the path 610 (e.g., into bonus section 620g, as shown in FIG. 6F), an additional wager is received, an avatar triggering signal is generated or received, etc. The player's avatars 630A may move along the path 610 in the manner described above. In one example, the player may receive a sum of respective awards associated with the sections 620 of the path 610 corresponding to the stopping locations of the player's avatars 630A. In another example, the path game feature may function as a race, and the player may receive an award associated with an ending location of one of the player's avatars 630A that has moved furthest along the path 610. In yet another example, the player may select among the respective awards associated with the ending locations of the player's avatars 630A on the path 610.

In an example shown in FIG. 6G, the gaming system 100 may present different sections 620a-620n of the path 610 as having different sizes, shapes, etc. For example, the gaming system 100 may display certain sections 620 of path 610 as spanning relatively smaller amounts of pixels while displaying other sections of the path 610 as spanning relatively larger amounts of pixels. The movement rate of the player's avatar 630A may be associated with a certain number of pixels per time period, per wager, per play, etc. Thus, in travelling around the path 610, the player's avatar 630A may spend relatively different lengths of times in different sections 620. The relative sizes and/or shapes of the sections 620 may vary during the path game feature, such as to enlarge sections 620 associated with certain awards as a bonus, based on wagers by the player, based on a presence of certain symbol combinations in the slot reel game, etc.

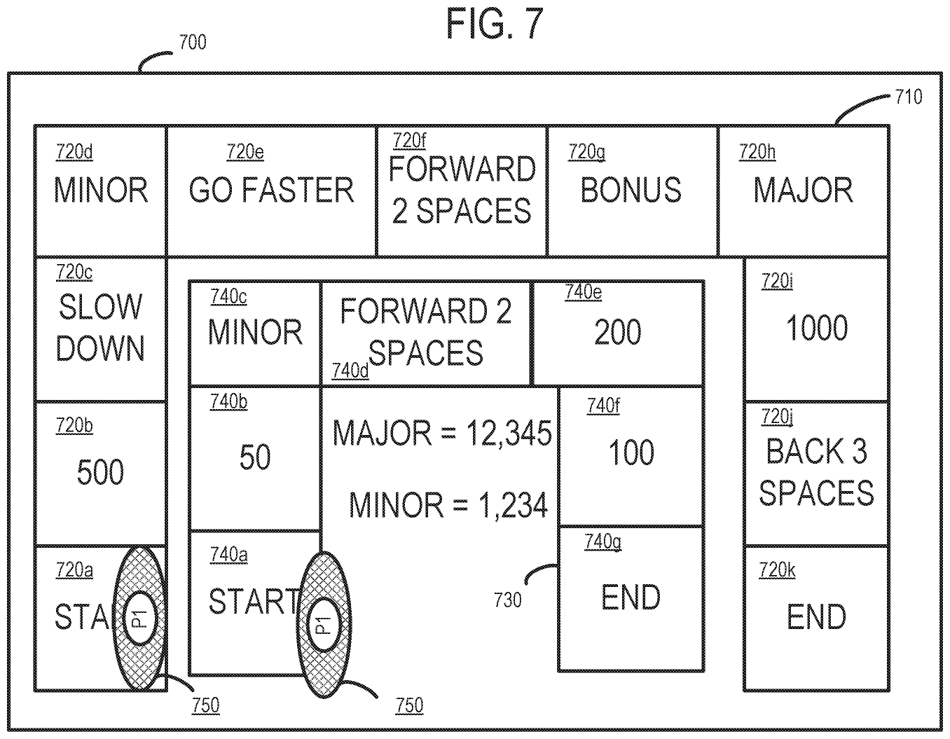

FIG. 7 shows a picture of a gaming system display illustrating a path game feature in accordance with another aspect of the present disclosure. For the sake of brevity, FIG. 7 shares features similar to the features already discussed above in connection with FIGS. 3A, 3B, 4A, 4B, 5A-5F, and 6A-6G, and such similar feature will not be described again. FIG. 7 illustrates a screen shot of one implementation of a gaming system that provides a path game feature. FIG. 7 illustrates a certain implementation of a game screen 700 that the gaming system 100 may display on a display device of the gaming system. In some implementations, game screen 700 may be displayed on second display 130 of gaming system 100 illustrated in FIG. 1. However, any other suitable display may be used.

The game screen 700 displays a first path 710 that includes first sections 720a-720k (referred to individually as first section 720 and collectively as first sections 720), a second path 730 that includes second sections 740a-740g (referred to individually as second section 740 and collectively as second sections 740), and one or more avatars 750, as illustrated in FIG. 7 for the path game feature. It should be appreciated that the game shown in game screen 700 is merely representative and may have more, fewer or different game elements (e.g., paths, sections, avatars, etc.) than those shown in the game screen 700.

As shown in FIG. 7, the first path 710 may be relatively longer than the second 730, such as the game screen 700 including more first sections 720 than second sections 740. Additionally or alternatively, the first path 710 may include a bonus award section 720g and/or relatively higher specific awards first section 720b and 720i in comparison the specific awards second section 740b and 740f At the same time, the first path 710 may include certain path game hazards, such as slow down section 720c and move back section 720i that are not included in the second path 730. Thus, the first path 710 may represent more risky option with relatively higher possible awards in comparison to the second path 730. In one example, the gaming system 100 may position the avatar 750 on the first path 710 (e.g., as shown in FIG. 7) when the player places a relatively higher wager (e.g., a wager that exceeds a predetermined threshold) or on the second path when the player places a relatively lower wager (e.g., a wager that is at or below the predetermined threshold). In some implementations, a player with an avatar placed on one of the paths can place an additional wager to move the player's avatar to the other path. Additionally or alternatively, the gaming system 100 may position the avatar 750 on the first path 710 (as shown in FIG. 7) when certain combinations of symbols are displayed in the base game or on the second path 730 when other combinations of symbols are displayed in the base game. In another example shown in FIG. 7, the gaming system 100 may position the avatars 750 on both the first path 710 and on the second path 730, and the player may receive respective awards associated with stop positions of the avatars 750 along the first path 710 and the second path 730. It should be appreciated that the gaming system 100 may position and move one or more avatars for the computer and/or one or more avatars associated with other players on the first path 710 and the second path 730, as previously described.

In some implementations, the gaming system 100 may position one or more avatars 750 on the first path 710 at the start of the path game feature. If one of the avatars bumps another one of the avatars on the first path 710, the gaming system may cause one of the bumped avatars to move or fall to the second path 730. The avatar that moves or falls to the second path 730 may be limited to winning awards on the second path 730 and not the first path 710 in some implementations. The gaming system may randomly determine which of the bumped avatars to move to the second path 730. In some implementations, the avatar moved to the second path 730 remains on the second path for the duration of the path game feature. In some implementations, the avatar moved to the second path 730 remains on the second path for some predetermined time period or a predetermined quantities of plays of the base game. In some implementations, a player with an avatar moved to the second path 730 can place a wager to move the avatar back to the first path 710.

In some implementations, the path game feature resemble a static wheel of awards placed in various segmented sections of the static wheel. The gaming system may display an award indicator as randomly moving along or otherwise being randomly repositioned on different segmented sections of the static wheel during a bonus game. The gaming system indicate which of the awards the player wins when the gaming system stops the award indicator one or more particular segmented sections of the static wheel.

Based on the forgoing description, it should be appreciated that a gaming system and method with improvements to game outcomes by providing a path game feature creates new and very exciting ways for a player to obtain improved winnings with a potential to earn greater awards. Such a potential to earn greater awards creates a greatly improved sense of anticipation for players.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations of the invention have been described. Various modifications may be made without departing from the spirit and scope of the invention. For example, various forms of the flows shown above may be used, with steps re-ordered, added, or removed. Accordingly, other implementations are within the scope of the following claims.

We claim:

1. A gaming system comprising:
a cabinet;
a processor;
a display device supported by the cabinet;
an input device supported by the cabinet;
a value acceptor supported by the cabinet;
a value dispenser supported by the cabinet;
a memory device that stores a plurality of instructions which, when executed by the processor, cause the processor to:
establish a credit balance based on a monetary value received by the value acceptor;
decrease the credit balance by a wager amount received via the input device;
randomly generate a plurality of symbols from a plurality of symbol sets;
display, on the display device, the plurality of symbols in a plurality of symbol display areas;
evaluate the plurality of symbols for winning symbol combinations;
display, on the display device, a first award corresponding to any winning symbol combinations, the credit balance being increased by the first award;
determine that a bonus feature has been triggered;
when the bonus feature is triggered:
display, on the display device, a plurality of path sections that are arranged into a path, and an avatar that is moved along the path until a stop condition is triggered, and
display, on the display device, a second award corresponding to one of the path sections associated with a location of the avatar when the stop condition is triggered, the credit balance being increased by the second award; and
issue value from the value dispenser based on the credit balance upon receipt of a cash out request.

2. The gaming system of claim 1, wherein the plurality of instructions further cause the processor, when determining that the bonus feature has been triggered to:
evaluate the plurality of symbols for triggering symbol combinations; and
determine that a bonus feature has been triggered when the plurality of symbols include one or more of the triggering symbol combinations.

3. The gaming system of claim 1, wherein the avatar moves along the path according to a movement rate, and the movement rate is adjusted based on one of the path sections associated with a location of the avatar before the stop condition is triggered.

4. The gaming system of claim 1, wherein the plurality of instructions further cause the processor to determine a movement rate of the avatar along the path based on the plurality of symbols displayed in the plurality of symbol display areas.

5. The gaming system of claim 1, wherein the plurality of instructions further cause the processor to determine a movement rate of the avatar along the path based on the wager amount.

6. The gaming system of claim 1, wherein the avatar is a first avatar, and wherein the plurality of instructions further cause the processor, when the bonus feature is triggered, to:
display, on the display device, a second avatar that is moved along the path until a stop condition is triggered; and
determine the second award further based on another one of the path sections associated with a location of the second avatar when the stop condition is triggered.

7. The gaming system of claim 1, wherein the avatar is a first avatar, and wherein the plurality of instructions further cause the processor, when the bonus feature is triggered, to:
display, on the display device, a second avatar in one of the path sections associated with the second avatar; and
prevent the first avatar from entering the one of the path sections associated with the second avatar.

8. The gaming system of claim 7, wherein the avatar is a first avatar, and wherein the plurality of instructions further cause the processor, when the bonus feature is triggered, to:
move the second avatar along the path until the stop condition is triggered; and
increase the credit balance by the second award when the first avatar is positioned ahead of the second avatar on the path.

9. The gaming system of claim 7, wherein the second avatar is associated with another player or with a non-playing character.

10. The gaming system of claim 1, wherein the second award further corresponds to one of the path sections through which the avatar passes before the stop condition is triggered.

11. The gaming system of claim 1, wherein the plurality of instructions further cause the processor to determine that the stop condition is triggered when a movement rate of the avatar is less than a threshold movement rate.

12. The gaming system of claim 1, wherein the plurality of instructions further cause the processor to determine that the stop condition is triggered when an input is received via a bonus controller.

13. The gaming system of claim 1, wherein the path is a first path, and the avatar is a first avatar, and wherein the plurality of instructions further cause the processor, when the bonus feature is triggered, to:
display, on the display device, another plurality of path sections that are arranged into a second path, and a second avatar that is moved along the second path until the stop condition is triggered; and
determine the second award further based on one of the other plurality of path sections associated with a location of the second avatar when the stop condition is triggered.

14. The gaming system of claim 1, wherein the plurality of instructions further cause the processor, when the bonus feature is triggered, to:
arrange a plurality of path sections such that the path is formed as a closed loop, and
move the avatar around the path until the stop condition is triggered.

15. A method of operating a gaming system, the method comprising:
receiving, by a monetary value acceptor, a monetary value;
establishing, by a processor of the gaming system, a credit balance based at least in part on the received monetary value;
accepting, from an input device in a housing of the gaming system, a wager amount;
decreasing, by the processor, the credit balance by the wager amount;
randomly generating a plurality of symbols from a plurality of symbol sets;
displaying, on the display device, the plurality of symbols in a plurality of symbol display areas;
evaluating the plurality of symbols for winning symbol combinations;
displaying, on the display device, a first award corresponding to any winning symbol combinations, the credit balance being increased by the first award;
determining that a bonus feature has been triggered;
when the bonus feature is triggered:
displaying, on the display device, a plurality of path sections that are arranged into a path, and an avatar that is moved along the path until a stop condition is triggered, and
displaying, on the display device, a second award corresponding to one of the path sections associated with a location of the avatar when the stop condition is triggered, the credit balance being increased by the second award; and
issuing value from a value dispenser based on the credit balance upon receipt of a cash out request.

16. The method of operating the gaming system of claim 15, wherein the avatar moves along the path according to a movement rate, and the movement rate is adjusted based on one of the path sections associated with a location of the avatar before the stop condition is triggered.

17. The method of operating the gaming system of claim 15, further comprising:
determining a movement rate of the avatar along the path based on the plurality of symbols displayed in the plurality of symbol display areas.

18. The method of operating the gaming system of claim 15, wherein the avatar is a first avatar, and wherein the method further comprises:
displaying, on the display device, a second avatar that is moved along the path until a stop condition is triggered; and
determining the second award further based on another one of the path sections associated with a location of the second avatar when the stop condition is triggered.

19. The method of operating the gaming system of claim 15, wherein the path is a first path, and the avatar is a first avatar, and wherein method further comprises:
displaying, on the display device, another plurality of path sections that are arranged into a second path, and a second avatar that is moved along the second path until the stop condition is triggered; and
determining the second award further based on one of the other plurality of path sections associated with a location of the second avatar when the stop condition is triggered.

20. A non-transitory computer-readable storage medium having machine instructions stored therein, the instructions being executable by a processor to cause the processor to:
establish a credit balance based at least in part on a monetary value received by a value acceptor of a gaming device;
place a wager following receipt of a wager input via an input device;
decrease the credit balance by the wager;
randomly generate a plurality of symbols from a plurality of symbol sets;
provide for display, on a display device, the plurality of symbols in a plurality of symbol display areas;
evaluate the plurality of symbols for winning symbol combinations;
display, on the display device, a first award corresponding to any winning symbol combinations, the credit balance being increased by the first award;
determine that a bonus feature has been triggered;
when the bonus feature is triggered:
display, on the display device, a plurality of path sections that are arranged into a path, and an avatar that is moved along the path until a stop condition is triggered, and
display, on the display device, a second award corresponding to one of the path sections associated with a location of the avatar when the stop condition is triggered, the credit balance being increased by the second award; and
issue value from a value dispenser based on the credit balance upon receipt of a cash out request.
